(19) United States
(12) Patent Application Publication
(10) Pub. No.: US 2026/0046659 A1
(43) Pub. Date: Feb. 12, 2026

(54) MANAGING MEASUREMENT GAP FOR A USER EQUIPMENT

(71) Applicant: GOOGLE LLC, Mountain View, CA (US)

(72) Inventor: Chih-Hsiang Wu, Taoyuan City (TW)

(21) Appl. No.: 19/101,462

(22) PCT Filed: Aug. 5, 2023
(86) PCT No.: PCT/US23/29582

§ 371 Date: Feb. 5, 2025

Related U.S. Application Data
(60) Provisional application No. 63/395,724, filed on Aug. 5, 2022.

(51) Int. Cl. H04W 24/10; H04W 72/12; H04W 88/06

(52) U.S. Cl. CPC H04W 24/10; H04W 72/12; H04W 88/06

(57) ABSTRACT

A node of a radio access network (RAN) implemented a method for managing communications with a UE configured to communicate in dual connectivity (DC). The node receives, from the other node, a message including (i) a configuration for a measurement gap which the UE uses for reference signal measurements and (ii) a status of the configuration. The node then manages a scheduling of the communications between the UE and the node in accordance with the status of the configuration.

### CROSS-REFERENCE TO RELATED APPLICATION

This application claims priority to and the benefit of the filing date of provisional U.S. patent application Ser. No. 63/395,724, entitled “Managing Measurement Gap for a User Equipment,” filed on Aug. 5, 2023. The entire contents of the provisional application are hereby expressly incorporated herein by reference.

### FIELD OF THE DISCLOSURE

This disclosure relates generally to wireless communications and, more particularly, to managing gap configuration(s) for a user equipment (UE) for measurement gap coordination and/or data transmission.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which provides logical channels to the Radio Link Control (RLC) sublayer. The RLC sublayer similarly provides data transfer services to the Packet Data Convergence Protocol (PDCP) sublayer. The Radio Resource Control (RRC) sublayer is disposed above the PDCP sublayer.

The UE sometimes can concurrently utilize resources of multiple radio access network (RAN) nodes, such as base stations or components of a distributed base station, interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

A UE can monitor signals in cells other than the cell in which the UE currently operates, i.e., the serving cell. To this end, base stations generate synchronization signals such as a Synchronization Signal (SS) and Physical Broadcast Channel (PBCH) Block (SSB). Each cell can have a particular configuration of SSB periodicity. According to 3GPP specifications, a UE receives a SSB-based RRM Measurement Timing Configuration (SMTC) for a certain carrier frequency in order to determine the SSB periodicity setting and the burst duration. Further, an SMTC can indicate the timing offset of the SSB burst in a frame. When a UE performs inter-frequency measurements by receiving and processing SSBs on non-serving frequencies, the UE does not monitor the serving frequency during a time period referred to as the measurement gap.

Several new measurement gap operations were introduced recently. These operations pertain to pre-configured gap pattern(s) per configured bandwidth part (BWP), concurrent and independent gap patterns, and Network Controlled Small Gap (NCSG). With these new measurement gap operations, technical issues arise in operations of dual connectivity and in applications to disaggregated base stations.

### BRIEF DESCRIPTION OF THE DRAWINGS

FIG. 1A is a block diagram of an example wireless communication system in which a user device and/or a network node(s) of a radio access network (RAN) can implement methods for managing measurement gap configuration(s);

FIG. 1B is another block diagram of an example system in which a RAN and a user device can implement methods for managing measurement gap configuration(s);

FIG. 1C is a block diagram of an example base station in which a centralized unit (CU) and a distributed unit (DU) can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIGS. 3A-3E are messaging diagrams illustrating example scenarios in which an MN and/or an SN configure and manage measurement gap configuration(s) for a UE that initially operates in SC with the MN and transitions to operating in DC with the MN and the SN;

FIGS. 4A-4C are messaging diagrams illustrating example scenarios in which an MN and/or an SN configure and manage measurement gap configuration(s) for a UE operating in DC with the MN and the SN;

FIG. 5 is a messaging diagram of an example scenario in which an MN configures a network-controlled small gap (NCSG) configuration for a UE;

FIG. 6 is a messaging diagram of an example scenario in which an MN configures a list of measurement gap configuration(s) for a UE;

FIGS. 7A-7E are messaging diagrams illustrating example scenarios similar to the scenarios illustrated in FIGS. 3A-3E, respectively, where a CU and a master DU of a base station collectively operate as the MN, and the CU and a secondary DU of the base station collectively operate as the SN;

FIGS. 8A-8C are messaging diagrams illustrating example scenarios similar to the scenarios illustrated in FIGS. 4A-4C, respectively, where a CU and a master DU of a base station collectively operate as the MN, and the CU and a secondary DU of the base station collectively operate as the SN;

FIG. 9 is a flow diagram of an example method, which can be implemented by a first RAN node, for sending measurement gap configuration(s) to a second RAN node;

FIGS. 10-11 are flow diagrams of example methods, which can be implemented by a first RAN node, for avoiding scheduling DL and/or UL transmissions with a UE within gap(s) configured by a second RAN node;

FIGS. 12-13 are flow diagrams of example methods, which can be implemented by a first RAN node, for transmitting a measurement gap configuration for a UE to a second RAN node; and

FIGS. 14-15 are flow diagrams of an example methods, which can be implemented by a first RAN node, for transmitting a list of measurement gap configuration(s) for a UE to a second RAN node.

### DETAILED DESCRIPTION OF THE DRAWINGS

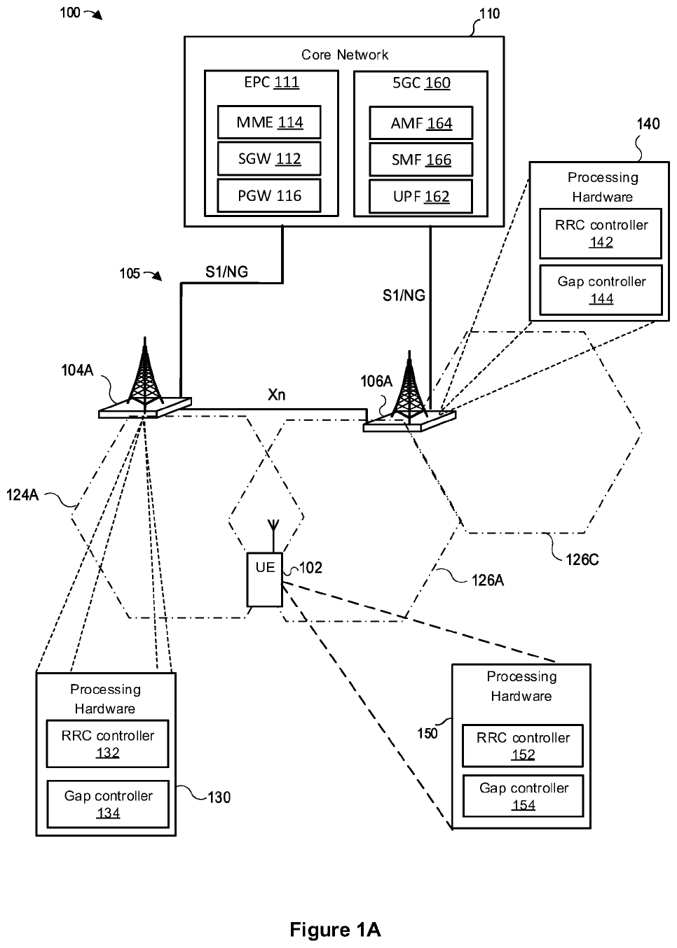

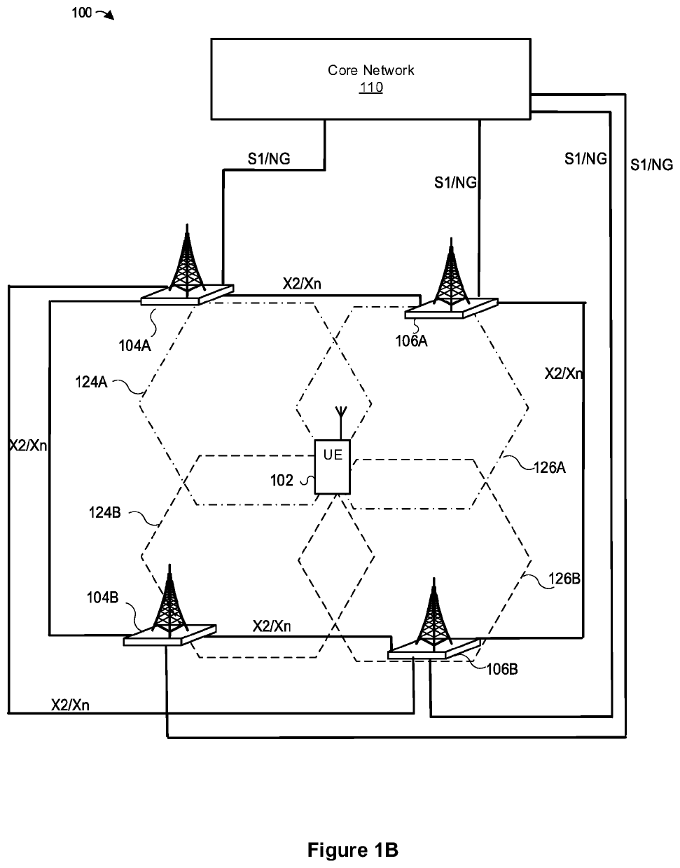

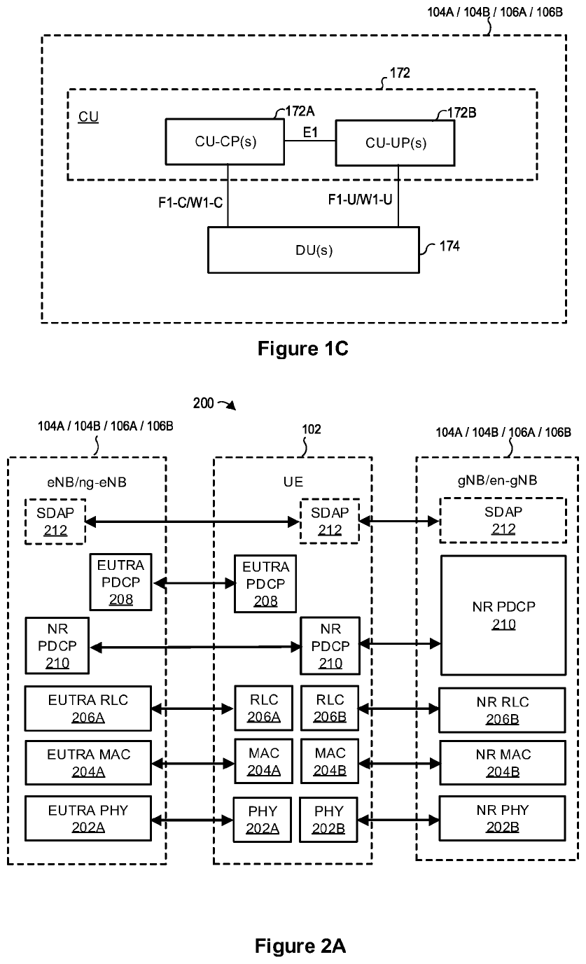

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc. ; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Radio Resource Control (RRC) controller 132 to implement procedures and messaging at the RRC sublayer of the protocol communication stack to configure one or more user devices. The processing hardware 130 can also include a measurement gap controller 134 configured to manage measurement gaps for one or more UEs communicating with the base station 104A. The base station 106A can include generally similar components. In particular, components 140, 142, and 144 of the base station 106A can be similar to the components 130, 132, and 134, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC controller 152 configured to manage procedures and messaging at the RRC sublayer of the protocol communication stack to communicate with the RAN 105 (e.g., base station 104 or 106). The processing hardware 150 can also include a measurement gap controller 154 configured to manage measurement gaps configured by the RAN 105.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

FIG. 1C depicts an example distributed or disaggregated implementation of any one or more of the base stations 104, 106. In this implementation, the base stations 104, 106 include a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller (e.g., the RRC container 132, 142) and/or an RRC inactive controller. In some implementations, the CU 172 includes a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 includes a logical node CU-CP 172A that hosts the control plane part of the PDCP protocol of the CU 172. In further implementations, the CU 172 includes a logical node CU-UP 172B that hosts the user plane part of the PDCP protocol and/or Service Data Adaptation Protocol (SDAP) protocol of the CU 172. Depending on the implementation, the CU-CP 172A transmits control information (e.g., RRC messages, F1 application protocol messages), and the CU-UP 172B transmits the data packets (e.g., SDAP PDUs or Internet Protocol packets).

The CU-CP 172A can connect to multiple CU-UP 172B through the El interface. The CU-CP 172A selects the appropriate CU-UP 172B for the requested services for the UE 102. In some implementations, a single CU-UP 172B connects to multiple CU-CP 172A through the E1 interface. The CU-CP 172A can connect to one or more DU 174's through an F1-C interface. The CU-UP 172B can connect to one or more DU 174 through the F1-U interface under the control of the same CU-CP 172A. In some implementations, one DU 174 connects to multiple CU-UP 172B under the control of the same CU-CP 172A. In such implementations, the CU-CP 172A establishes the connectivity between a CU-UP 172B and a DU 174 by using Bearer Context Management functions.

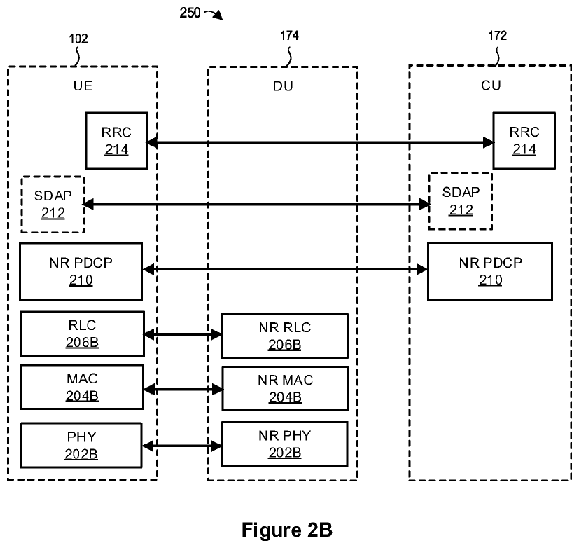

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. In some implementations, the NR PDCP sublayer 210 then provides data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

In some implementations, on a control plane, the EUTRA PDCP sublayer 208 and the NR PDCP sublayer 210 provides signaling radio bearers (SRBs) or RRC sublayer (not shown in FIG. 2A) to exchange RRC messages, non-access-stratum (NAS) messages or LPP messages, for example. In further implementations, on a user plane, the EUTRA PDCP sublayer 208 and the NR PDCP sublayer 210 provides Data Radio Bearers (DRBs) to support data exchange. Data exchanged on the NR PDCP sublayer 210 can be SDAP PDUs, Internet Protocol (IP) packets, or Ethernet packets.

FIG. 2B illustrates, in a simplified manner, an example protocol stack 250, via which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

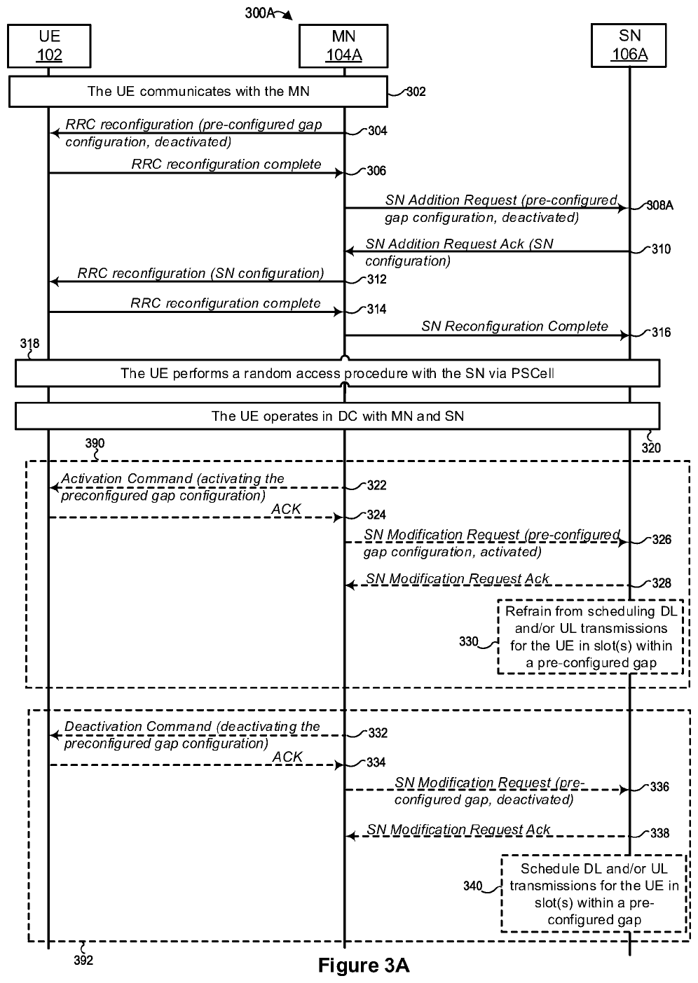

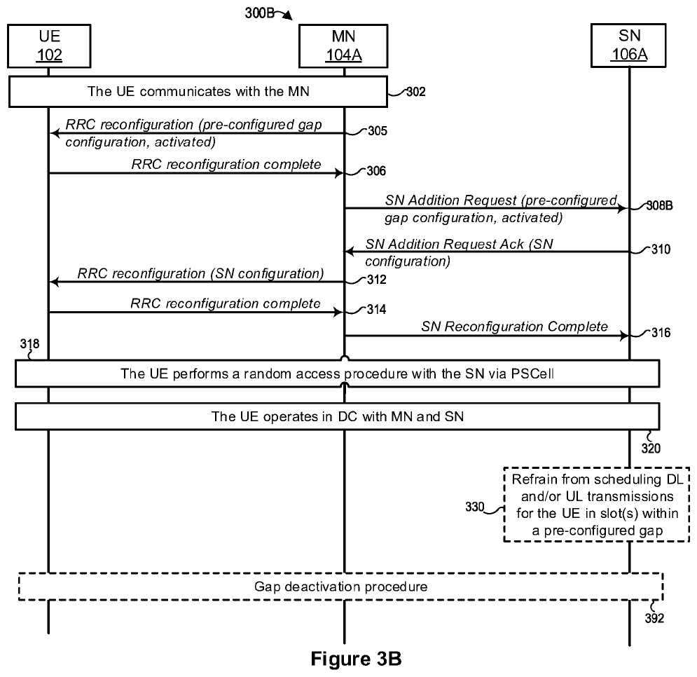

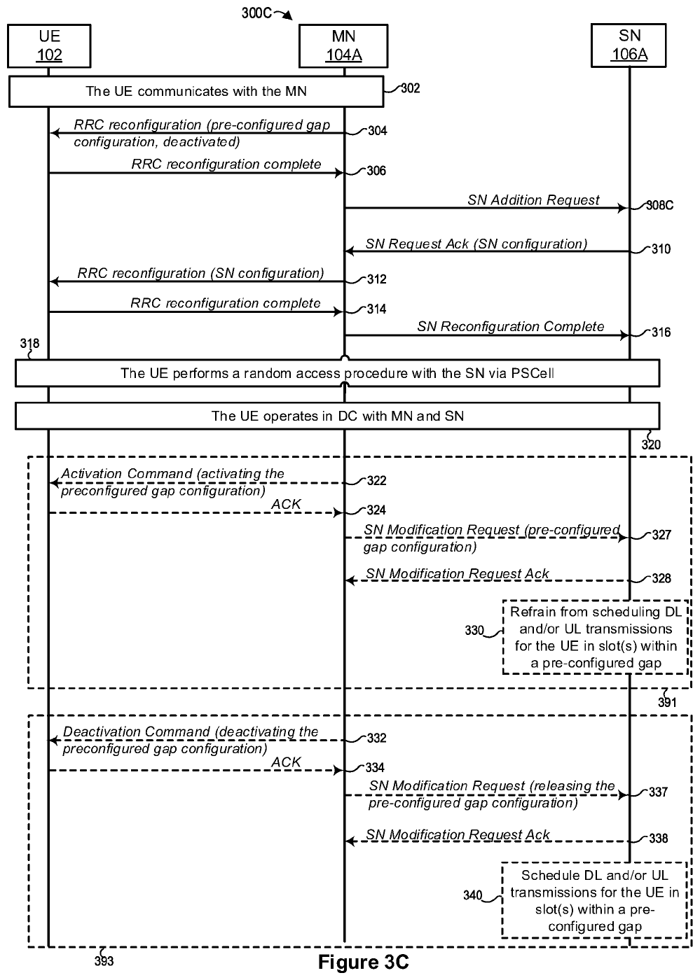

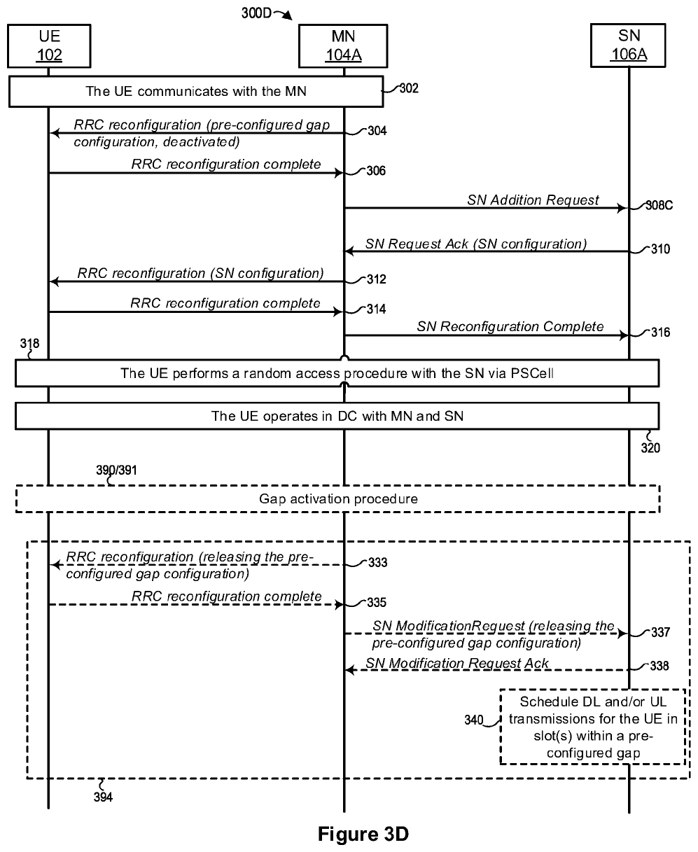

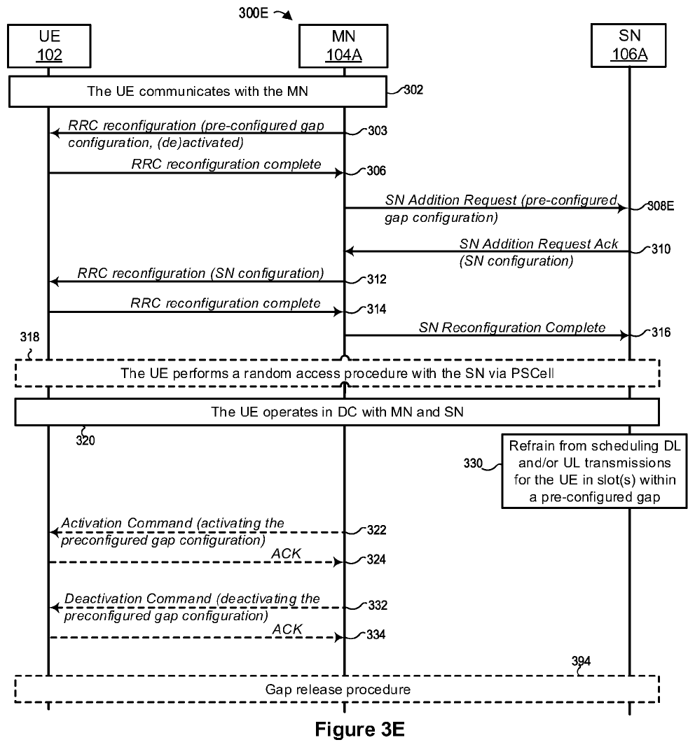

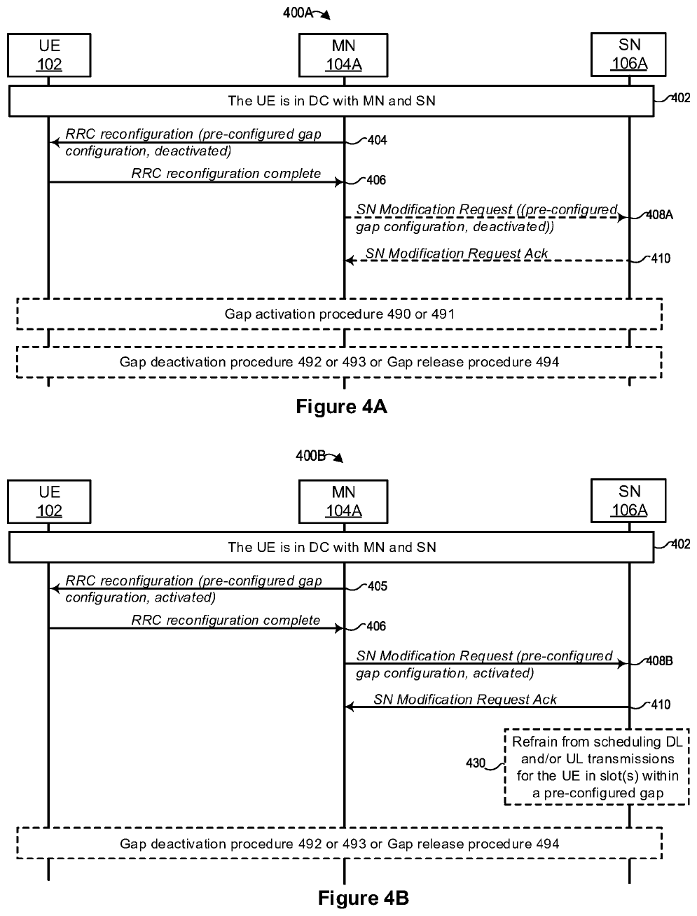

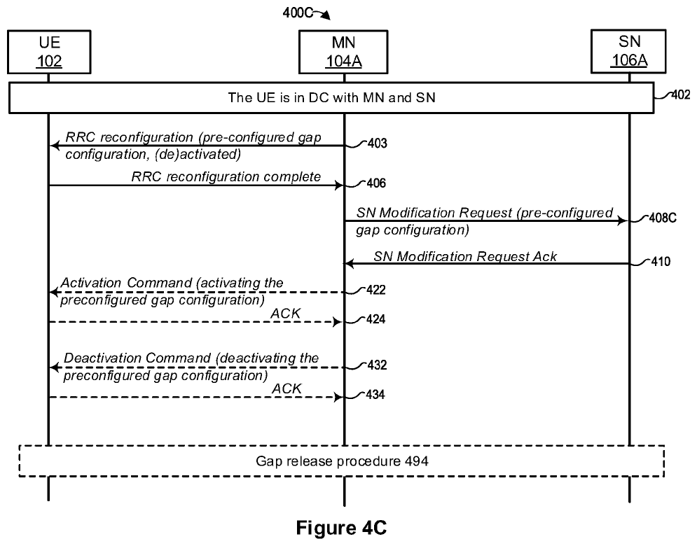

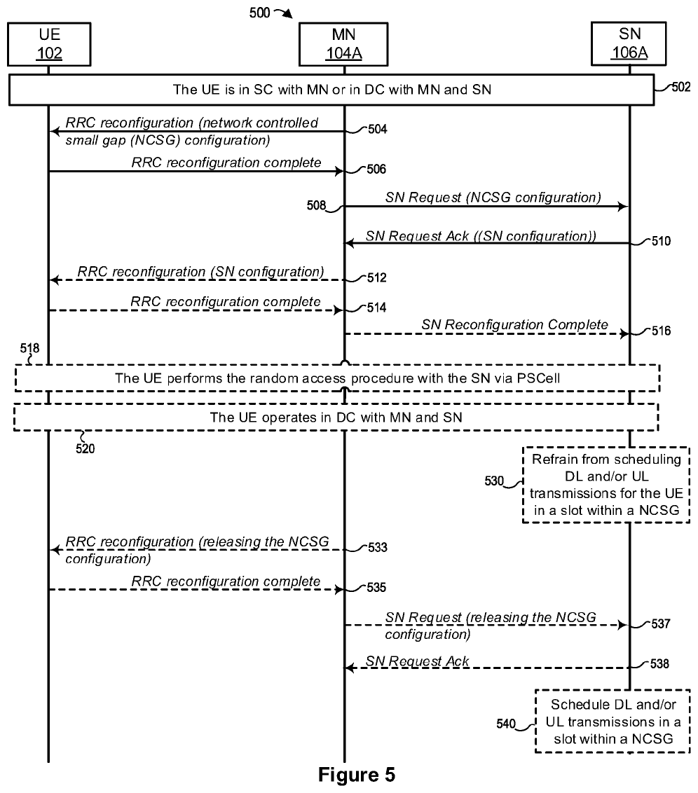

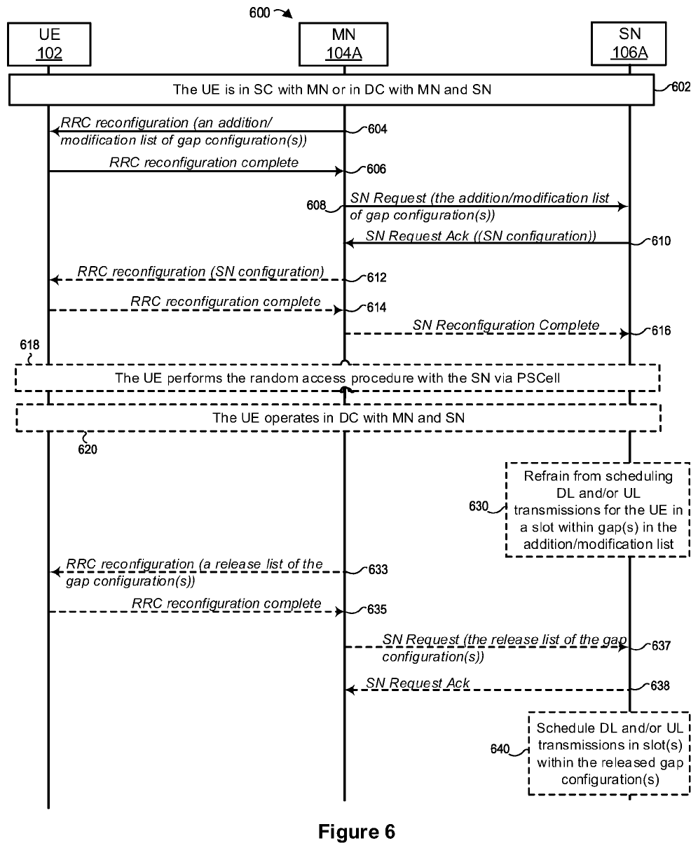

Next, several example scenarios that involve several components of FIG. 1A-1C and relate to managing measurement gap configuration(s) are discussed with reference to FIGS. 3A-8C. Generally speaking, similar events in FIGS. 3A-8C are labeled with the similar reference numbers (e.g., event 304 in FIG. 3A is similar to event 304 in FIGS. 3C and 3D, event 404 in FIG. 4A, event 504 in FIG. 5, and event 604 in FIG. 6, event 305 in FIG. 3B is similar to event 405 in FIG. 4B, and event 303 in FIG. 3E is similar to event 403 in FIG. 4C), with differences discussed below where relevant. With the exception of the differences shown in the figures and discussed below, any of the alternative implementations discussed with respect to a particular event (e.g., for messaging and processing) may apply to events labeled with similar reference numbers in other figures and also to both integrated and distributed base stations.

Referring first to FIG. 3A, the base station 104A in a scenario 300A operates as an MN, and the base station 106A operates as a SN. Initially, the UE 102 communicates 302 data (e.g., UL PDUs and/or DL PDUs) with MN 104A. In some implementations, the UE 102 operates in single connectivity (SC) with the MN 104A in event 302. In other implementations, the UE 102 operates in dual connectivity (DC) with the MN 104A and base station 106B operating as a SN (not shown in FIG. 3A). While communicating with the UE 102 in SC or in DC with the SN 106B, the MN 104A transmits 304 a RRC reconfiguration message (e.g., RRCReconfiguration message) including a pre-configured gap configuration to the UE 102 to configure a pre-configured gap pattern for the UE 102. In response, the UE 102 transmits 306 a RRC reconfiguration complete message (e.g., RRCReconfigurationComplete message) to the MN 104A. In some implementations, the MN 104A includes, in the RRC reconfiguration message, a first indication indicating the preconfigured gap configuration (i.e., the preconfigured gap pattern) is deactivated (i.e., not activated yet). In one implementation, the MN 104A includes the first indication in the pre-configured gap configuration. In another implementation, the MN 104A includes the first indication in a particular configuration other than the pre-configured gap configuration. For example, the configuration can be a BWP configuration, non-BWP configuration or cell group configuration (e.g., CellGroupConfig) included in the RRC reconfiguration message. In other implementations, the RRC reconfiguration message does not include an indication indicating the pre-configured gap configuration is deactivated, and the pre-configured gap configuration is configured and initially deactivated by default, e.g., which can be defined in a 3GPP specification. Thus, the UE 102 and MN 104A determine the pre-configured gap configuration is deactivated when the pre-configured gap configuration is initially configured. That is, the UE 102 does not use the pre-configured gap pattern to perform measurements before the pre-configured gap pattern is activated. In other words, the UE 102 attempts to receive from the MN 104A scheduling commands (e.g., Downlink Control Information (DCIs) scheduling DL transmissions and/or UL transmissions, during gaps in the deactivated pre-configured gap pattern. The UE 102 receives the DL transmissions and/or transmits UL transmissions that may or may not be within the gaps, in accordance with the scheduling commands. Because the pre-configured gap pattern is deactivated, the MN 104A may schedule DL transmissions and/or UL transmissions during gaps in the pre-configured gap pattern. If the UE 102 is configured by the MN 104A to transmit channel state information (CSI) and/or sounding reference signal (SRS) and transmissions of CSI and SRS are within the gaps, the UE 102 can transmit the CSI and SRS during the gaps to the MN 104A. If the UE 102 is configured with a scheduling request (SR) configuration and determines to request the MN 104A to schedule UL resources, the UE 102 can transmit a SR to the MN 104A during a gap in the deactivated pre-configured gap pattern. During the gaps in the deactivated preconfigured gap pattern, the UE 102 can transmit HARQ feedback for DL transmissions to the MN 104A. In these cases, the MN 104A attempts to receive or receives the transmissions of CSI, SRS, SR and/or HARQ feedback from the UE 102 during the gaps. The HARQ feedback includes HARQ acknowledgements or negative ACKs (NACKs).

In some implementations, the MN 104A configures the pre-configured gap configuration for positioning measurement. In other implementations, the MN 104A configures the pre-configured gap configuration for non-positioning measurement (e.g., inter-frequency measurement, intra-frequency measurement, inter-RAT measurement or inter-BWP measurement). The MN 104A generates the pre-configured gap configuration based on measurement related information. For example, the measurement related information includes reference signal configuration(s), measurement timing configuration(s) and/or information of measured frequency/frequencies. The reference signal configuration(s) configures location(s) of one or more reference signals to be measured.

In some implementations, the MN 104A includes a gap ID in the pre-configured gap configuration to identify the pre-configured gap configuration or pre-configured gap pattern. In some implementations, the gap ID is a MeasPosPreConfigGapId or MeasPosPreConfigGapId-r17. In other implementations, the gap ID is a MeasGapld or MeasGapId-r17. In some implementations, the MN 104A includes the pre-configured gap configuration in a MeasGapConfig IE and include the MeasGapConfig IE in the RRC reconfiguration message. In some implementations, the MN 104A includes the first indication in the MeasGapConfig IE. In some implementations, the pre-configured gap configuration is a GapConfig-r17 IE. In other implementations, the pre-configured gap configuration is a PosGapConfig-r17 IE.

At a later time, the MN 104 can determine that it should initiate a SN Addition or Change procedure to configure the base station 106A as a SN for the UE 102. The MN 104A can make this determination based on one or more measurement results received from the UE 102, for example, or another suitable event. In response to this determination, the MNA 104 sends 308A a SN Addition Request message including the pre-configured gap configuration to the SN 106A to perform the SN Addition or Change procedure. In some implementations, the MN 104A includes the pre-configured gap configuration in a container (e.g., an RRC inter-node IE such as a CG-ConfigInfo IE) and includes the container in the SN Addition Request message. In one implementation, the MN 104A includes the pre-configured gap configuration in a MeasGapConfig IE, includes the MeasGapConfig IE in a container (e.g., an RRC inter-node IE such as a CG-ConfigInfo IE) and includes the container in the SN Addition Request message. In another implementation, the MN 104A includes the pre-configured gap configuration in a configuration list without using a MeasGapConfig IE to wrap the pre-configured gap configuration or configuration list, includes the configuration list in a container (e.g., an RRC inter-node IE such as a CG-ConfigInfo IE) and includes the container in the SN Addition Request message. In some implementations, the configuration list is a gapToAddModList(-r17) IE. In other implementations, the configuration list is a PosMeasGapPreConfigToAddModList-r17 IE. In other implementations, the MN 104A includes the pre-configured gap configuration or the configuration list in a first IE of the SN Addition Request message instead of using an RRC inter-node IE.

The MN 104A can include a second indication indicating the preconfigured gap configuration is deactivated in the SN Addition Request message. In one implementation, the MN 104A includes the second indication in the container, MeasGapConfig IE or configuration list that are included in the SN Addition Request message. In other implementations, the MN 104A includes the second indication in the first IE or a second IE of the SN Addition Request message. In some implementations, the MeasGapConfig IE included in the SN Addition Request message and the MeasGapConfig IE included in the RRC reconfiguration message can be the same. In other implementations, the MeasGapConfig IE included in the SN Addition Request message and the MeasGapConfig IE included in the RRC reconfiguration message can be different.

In response to SN Addition Request message, the SN 106A sends 310 a SN Addition Request Acknowledge message including a SN configuration for the UE 102 to the MN 104A.

The SN configuration included in this message can include one or more configuration parameters for the UE 102 to communicate with the SN 106A. Upon receiving the SN Addition Request Acknowledge message, the MN 104A generates a RRC reconfiguration message including the SN configuration and transmits 312 the RRC reconfiguration message to the UE 102. In response, the UE 102 transmits 314 a RRC reconfiguration complete message to the MN 104A and performs 318 a random access procedure with the SN 106A via a primary secondary cell (PSCell) to connect to the SN 106A. In cases where the UE 102 is in DC with the MN 104A and SN 106B, the UE 102 disconnects from the SN 106B in response to receiving the RRC reconfiguration message or SN configuration. After the UE 102 successfully completes the random access procedure, the UE 102 operates 320 in DC with the MN 104A and SN 106A.

When receiving from the MN 104A an indication (e.g., the first or second indication) indicating the pre-configured gap configuration is deactivated, the SN 106A determines that the pre-configured gap configuration is not yet activated. In some implementations, the SN 106A can (temporarily) ignore the deactivated pre-configured gap pattern when scheduling DL transmissions and/or UL transmissions for the UE 102. As the SN 106A ignores the deactivated pre-configured pattern, the SN 106A can transmit the UE 102 Downlink Control Information (DCIs) to schedule DL transmissions for the UE 102 and transmit the scheduled DL transmissions to the UE 102, during gaps configured in the deactivated pre-configured gap pattern. As the UE 102 ignores the deactivated pre-configured gap pattern, the UE 102 receives the DCIs and scheduled DL transmissions from the SN 106A during gaps configured in the pre-configured gap pattern. In some implementations, the SN 106A refrains from performing gap coordination with the MN 104A for the deactivated pre-configured gap pattern. That is, if the SN 106A determines to configure a gap pattern (i.e., SN configured gap pattern) for the UE 102, the SN 106A does not consider to align the SN configured gap pattern with the deactivated pre-configured gap pattern or make the SN configured gap pattern and the deactivated pre-configured gap pattern overlap as much as possible. In other words, the SN 106A configures the SN configured gap pattern irrespective of the pre-configured gap pattern.

In some implementations, the SN configuration can include a cell group configuration (CellGroupConfig) IE that configure the PSCell and zero, one or more secondary cells (SCells). In some further implementations, the SN configuration includes configuration(s) such a radio bearer configuration and/or a measurement configuration. In one implementation, the SN 106A may include an RRCReconfiguration message including the CellGroupConfig IE and/or measurement configuration in the SN Addition Request Acknowledge message. In some implementations, the SN configuration can be an RRCReconfiguration message. The RRCReconfiguration message and CellGroupConfig IE can conform to 3GPP specification 38.331.

While communicating with the UE 102 operating in DC with the MN 104A and SN 106A, the MN 104A can transmit 322 to the UE 102 an activation command activating the pre-configured gap configuration. In some implementations, the UE 102 transmits 324 a first ACK to the MN 104A to indicate that the UE 102 receives the activation command. In some implementations, the MN 104A includes the gap ID of the pre-configured gap configuration or pattern in the activation command. Thus, the UE 102 can identify the pre-configured gap configuration or pattern to be activated in accordance with the gap ID. The UE 102 activates the pre-configured gap pattern in response to the activation command. During the activated pre-configured gap pattern, the UE 102 refrains from transmitting UL transmissions (e.g., HARQ feedback, SR, and CSI, SRS, PUSCH transmission) except for Msg3 or MSGA of a random access procedure. During the activated pre-configured gap pattern, the UE 102 refrains from receiving a PDSCH and/or monitoring a PDCCH, except that ra-Response Window or ra-ContentionResolutionTimer or msgB-Response Window is running.

In some implementations, the MN 1704A activates the pre-configured gap configuration in response to receiving a first CN-to-BS message from a core network (e.g., the CN 110). For example, the core network sends the first CN-to-BS message to request the MN 104A to activate the pre-configured gap configuration for the UE 102. In some implementations, the first CN-to-BS messages can be a Measurement Activation message (e.g., including an activation indication). In other implementations, the MN 104A activates the pre-configured gap configuration in response to receiving an activation request message from the UE 102. In some implementations, the activation request message is a UL MAC CE. In yet other implementations, the MN 104A activates the pre-configured gap in response to adding a new secondary cell (SCell) or changing an active BWP for the UE 102.

In some implementations, the MN 104A generates a MAC PDU including the activation command and transmits the MAC PDU to the UE 102 in event 322. In some implementations, the activation command is a first MAC control element (CE) and the MAC PDU includes a first subheader for the first MAC CE. For example, the first subheader includes a first (extended) logical channel ID (value) identifying the first MAC CE. In some implementations, the first ACK is a first HARQ ACK acknowledging reception of the MAC PDU. In other implementations, the first ACK is a MAC CE confirming reception of the first MAC CE. In other implementations, the activation command is an RRC message (e.g., RRC reconfiguration message) including an activation indication for the pre-configured gap configuration. In such cases, the first ACK can be a RRC response message (e.g., RRC reconfiguration complete message) or a RLC ACK.

After activating the pre-configured gap pattern, the MN 104A can transmit 326 an SN Modification Request message to the SN 106A. In response, the SN 106A transmits 328 a SN Modification Request Acknowledge message to the MN 104A. In some implementations, the MN 104A indicates the pre-configured gap configuration is activated in the SN Modification Request message. In some implementation, the MN 104A includes, in the SN Modification Request message, the pre-configured gap configuration and an activation indication indicating the pre-configured gap configuration is activated. In some implementations, the MN 104A includes the pre-configured gap configuration in a container (e.g., an RRC inter-node IE such as a CG-Config IE) and includes the container in the SN Modification Request message. In one implementation, the MN 104A includes the pre-configured gap configuration in a MeasGapConfig IE, includes the MeasGapConfig IE in a container (e.g., an RRC inter-node IE such as a CG-ConfigInfo IE), and includes the container in the SN Modification Request message. In another implementation, the MN 104A includes the pre-configured gap configuration in a configuration list, and includes the configuration list in a container (e.g., an RRC inter-node IE such as a CG-ConfigInfo IE) without using a MeasGapConfig IE to wrap the pre-configured gap configuration, and then includes the container in the SN Modification Request message. In other implementations, the MN 104A includes the pre-configured gap configuration in a first IE of the SN Modification Request message instead of using an RRC inter-node IE. Depending on the implementations, the MN 104A includes the activation indication in the pre-configured gap configuration, the GapConfig-r17 IE, MeasGapConfig IE, the container, the first IE, or a second IE of the SN Modification Request message. In other implementations, the MN 104A includes, in the SN Modification Request message, the gap ID of the pre-configured gap configuration or pattern instead of including the whole pre-configured gap configuration. Thus, the SN 106A can use the gap ID to identify the pre-configured gap configuration that the SN 106A received in event 308A. If the MN 104A includes the gap ID in an activation list (i.e., the name of the list indicates activation status), the MN 104A may not include the activation indication in the SN Modification Request message. In some implementations, the MN 104A can include the activation list in the container.

In some alternative implementations, the MN 104A transmits the SN Modification Request message of event 326 before transmitting the activation command of event 322 to the UE 102.

In response to the SN Modification Request message of event 326 or the activation indication, the SN 106A may refrain 330 from scheduling or transmitting DL transmissions for the UE 102 and/or scheduling UL transmissions within gaps in the pre-configured gap pattern. In some implementations, the DL transmissions can include CSI reference signal (CSI-RS), DCIs on PDCCH(s), and/or PDSCH transmission(s). In some implementations, the UL transmissions include PUSCH transmissions, SRS and/or CSI. In some implementations, the SN 106A performs gap coordination with the MN 104A based on the pre-configured gap pattern, in response to the SN Modification Request message of event 326 or the activation indication. If the SN 106A determines to configure a gap pattern (i.e., SN configured gap pattern) for the UE 102, the SN 106A aligns the SN configured gap pattern with the pre-configured gap pattern or make the SN configured gap pattern and the pre-configured gap pattern overlap. In some implementations, the SN 106A overlaps the SN-configured gap pattern and the pre-configured gap pattern as much as possible to save UE 102 power and/or meet UE 102 measurement needs. In some implementations, the SN 106A generates an SN gap configuration (re)configuring the SN-configured gap pattern and transmit a RRC reconfiguration message including the SN gap configuration to the UE 102 via the MN 104A or a radio connection (e.g., SRB3) between the UE 102 and SN 106A. The UE 102 uses the SN-configured gap pattern to perform measurements configured by the SN 106A.

The events 322, 324, 326, 328, and 330 are collectively referred to in FIG. 3A as a gap activation procedure 390.

After performing the gap activation procedure 390 with the UE 102, the MN 104A can transmit 332 to the UE 102 a deactivation command deactivating the (activated) pre-configured gap configuration. In some implementations, the UE 102 transmits 334 a second ACK to the MN 104A to indicate that the UE 102 receives the deactivation command. In some implementations, the MN 104A includes the gap ID of the pre-configured gap configuration or pattern in the deactivation command. Thus, the UE 102 identifies the pre-configured gap configuration or pattern to be deactivated in accordance with the gap ID. The UE 102 deactivates the pre-configured gap pattern in response to the deactivation command. The UE 102 retains the pre-configured gap configuration and does not use the deactivated pre-configured gap configuration after (e.g., in response to) receiving the deactivation command. At least some of the techniques discussed above in connection with the deactivated pre-configured gap configuration or pattern can apply here as well.

In some implementations, the MN 1704A deactivates the pre-configured gap configuration in response to receiving a second CN-to-BS message from a core network (e.g., the CN 110). For example, the core network sends the second CN-to-BS message to request the MN 104A to activate the pre-configured gap configuration for the UE 102. In some implementations, the second CN-to-BS messages is a Measurement Activation message (e.g., including a deactivation indication) or a Measurement Deactivation message. In other implementations, the MN 104A deactivates the pre-configured gap configuration in response to receiving a deactivation request message from the UE 102. In some implementations, the deactivation request message is a UL MAC CE. In yet other implementations, the MN 104A deactivates the pre-configured gap in response to releasing a SCell or changing an active BWP for the UE 102.

In some implementations, the MN 104A generates a MAC PDU including the deactivation command and transmits the MAC PDU to the UE in event 332. In some implementations, the deactivation command is a second MAC CE, and the MAC PDU includes a second subheader for the second MAC CE. In one implementation, the first MAC CE and second MACE have the same format and the second subheader is the same as the first subheader. In this implementation, the MN 104A sets a field in the format for the first MAC CE to a first value to indicate the first MAC CE is an activation command, and sets the field in the format for the second MAC CE to a second value to indicate the second MAC CE is a deactivation command. In another implementation, the second subheader includes a second (extended) logical channel ID (value) identifying the second MAC CE. In some implementations, the second ACK is a second HARQ ACK acknowledging reception of the MAC PDU. In other implementations, the second ACK is a MAC CE confirming reception of the second MAC CE. In other implementations, the deactivation command is a RRC message (e.g., RRC reconfiguration message) including a deactivation indication for the pre-configured gap configuration or excluding the activation indication for the pre-configured gap configuration. In such cases, the first ACK can be a RRC response message (e.g., RRC reconfiguration complete message) or a RLC ACK.

After (e.g., in response to) deactivating the pre-configured gap pattern, the MN 104A can transmit 336 a SN Modification Request message to the SN 106A. In response, the SN 106A transmits 338 a SN Modification Request Acknowledge message to the MN 104A. In some implementations, the MN 104A indicates the pre-configured gap configuration is deactivated in the SN Modification Request message of event 336, similar to event 308A. In some implementations, the MN 104A includes the pre-configured gap configuration in a container (e.g., an RRC inter-node IE such as a CG-ConfigInfo IE) and includes the container in the SN Modification Request message of event 336. In one implementation, the MN 104A includes the pre-configured gap configuration in a MeasGapConfig IE, includes the MeasGapConfig IE in a container (e.g., an RRC inter-node IE such as a CG-ConfigInfo IE) and includes the container in the SN Modification Request message of event 336. In another implementation, the MN 104A includes the pre-configured gap configuration in a GapConfig-r17 IE instead of a MeasGapConfig IE, includes the GapConfig-r17 IE in a container (e.g., an RRC inter-node IE such as a CG-ConfigInfo IE) and includes the container in the SN Modification Request message of event 336. In other implementations, the MN 104A includes the pre-configured gap configuration in a first IE of the SN Modification Request message of event 336 instead of using an RRC inter-node IE. In some implementations, the MN 104A can include a deactivation indication indicating the preconfigured gap configuration is deactivated in the SN Modification Request message of event 336. In one implementation, the MN 104A includes the deactivation indication in the container, MeasGapConfig IE or GapConfig-r17 IE. In other implementations, the MN 104A includes the deactivation indication in the first IE or a second IE of the SN Modification Request message of event 336.

In other implementations, the MN 104A includes, in the SN Modification Request message in event 336, the gap ID of the pre-configured gap configuration or pattern instead of including the whole pre-configured gap configuration. Thus, the SN 106A can use the gap ID to identify the pre-configured gap configuration that the SN 106A received in event 308A. If the MN 104A includes the gap ID in a deactivation list (i.e., the name of the list indicates deactivation status), the MN 104A may not include the deactivation indication in the SN Modification Request message of event 336. In some implementations, the MN 104A can include the deactivation list in the container.

In response to the SN Modification Request message of event 336, or the deactivation indication, in the SN Modification Request message of event 336, indicating the preconfigured gap configuration is deactivated, the SN 106A can schedule 340 DL and/or UL transmissions for the UE 102 within gaps in the pre-configured gap pattern. After (e.g., in response to) receiving the SN Modification Request message of event 336 or the deactivation indication, the SN 106A stops or refrains from performing gap coordination based on the pre-configured gap configuration.

In some alternative implementations, the MN 104A can transmit the SN Modification Request message of event 336 before transmitting the deactivation command of event 332 to the UE 102.

The events 332, 334, 336, 338, and 340 are collectively referred to in FIG. 3A as a gap deactivation procedure 392.

Referring next to FIG. 3B, a scenario 300B is generally similar to the scenario 300A. The differences between the scenario 300D and the scenarios 300A-C are discussed below.

In the scenario 300B, the MN 104A transmits 305 to the UE a RRC reconfiguration message including the pre-configured gap configuration, similar to events 304 and 322. The difference is that the MN 104A activates the pre-configured gap configuration in the RRC reconfiguration message in event 305 instead of deactivating the pre-configured gap configuration in the RRC reconfiguration message in event 304. Thus, the MN 104A transmits 308B to the SN 106A a SN Addition Request message including the pre-configured gap configuration, similar to event 308A and 326. The difference between event 308B and 308A is that the MN 104A indicates the pre-configured gap configuration is activated in the SN Addition Request message. The SN 106A determines that the pre-configured gap configuration or pattern is activated between the MN 104A and UE 102 in accordance with the SN Addition Request message in event 308B and performs actions (e.g., event 330 and/or gap coordination) in response to the determination or based on the activated pre-configured gap configuration, similar to event 326 of FIG. 3A. At a later time, the MN 104A, SN 106A and the UE 102 can perform the gap deactivation procedure 392 as described for FIG. 3A.

Referring next to FIG. 3C, a scenario 300C is generally similar to the scenarios 300A and 300B. The differences between the scenarios 300C and the scenarios 300A-B are discussed below.

In the scenario 300C, the MN 104A transmits 308C a SN Addition Request message to the SN 106A, similar to events 308A and 308C, but the MN 104A does not include the pre-configured gap configuration in the SN Addition Request message in event 308C. That is, the 19 MN 104A does not provide any information for the pre-configured gap configuration in the SN Addition Request message in event 308C. Thus, the SN 106A does not receive the pre-configured gap configuration from the MN 104A.

After activating the pre-configured gap pattern, the MN 104A can transmit 327 a SN Modification Request message to the SN 106A, similar to event 326, except that the MN 104A may or may not indicate the activation status for the pre-configured gap configuration in the SN Modification Request message in event 327. After deactivating the pre-configured gap configuration, the MN 104A can transmit 337 a SN Modification Request message to the SN 106A, similar to event 336, except that the MN 104A indicates releasing the pre-configured gap configuration in the SN Modification Request message in event 337. In some implementations, the MN 104A includes a release list including the gap ID of the pre-configured gap to indicate the SN 106A that the pre-configured gap configuration is released. Thus, the MN 104A does not include the pre-configured gap configuration in the SN Modification Request message in event 337. In some implementations, the release list is gapToReleaseList-r17. In other implementations, the release list is a posMeasGapPreConfigToReleaseList-r17.

In response to the SN Modification Request message of event 337 or the release list including the gap ID, the SN 106A releases the pre-configured gap configuration and can schedule 340 DL and/or UL transmissions for the UE 102 within gaps in the pre-configured gap pattern. Because the SN 106A releases the pre-configured gap configuration, the SN 106A is not required to perform gap coordination based on the pre-configured gap configuration. In some alternative implementations, the MN 104A can transmit the SN Modification Request message of event 337 before transmitting the deactivation command of event 332 to the UE 102.

The events 322, 324, 327, 328, and 330 are collectively referred to in FIG. 3C as a gap activation procedure 391. The events 332, 334, 337, 338, and 340 are collectively referred to in FIG. 3C as a gap deactivation procedure 393.

Referring next to FIG. 3D, a scenario 300D is generally similar to the scenarios 300A-C. The differences between the scenario 300D and the scenarios 300A-C are discussed below.

In the scenario 300D, after performing the gap activation procedure 390 or 391 with the UE 102, the MN 104A can determine to release pre-configured gap configuration. In response to the determination, the MN 104A transmit 333 to the UE 102 a RRC reconfiguration message releasing the pre-configured gap configuration. In response, the UE 102 releases the pre-configured gap configuration and transmits 335 a RRC reconfiguration complete message to the MN 104A. In some implementations, the MN 104A includes a release list including the gap ID of the pre-configured gap configuration in the RRC reconfiguration message to indicate the UE 102 to release the pre-configured gap configuration. The UE 102 can identify the pre-configured gap configuration to be released in accordance to the gap ID.

The events 333, 335, 337, 338, and 340 are collectively referred to in FIG. 3D as a gap release procedure 394.

Referring next to FIG. 3E, a scenario 300E is generally similar to the scenarios 300A-D. The differences between the scenario 300E and the scenarios 300A-D are discussed below.

In the scenario 300E, the MN 104A transmits 303 to the UE a RRC reconfiguration message including the pre-configured gap configuration, similar to event 304 or 305. The MN 104A can indicate the pre-configured gap configuration is deactivated or activated in the RRC reconfiguration message as described for event 304 or 305. The MN 104A then transmits 308E to the SN 106A a SN Addition Request message including the pre-configured gap configuration, similar to event 308B and 326. The difference between events 308E and events 308B and 326 is that the MN 104A does not indicate or include the status (i.e., activated or deactivated) of the pre-configured gap configuration in the SN Addition Request message in event 308E. The SN 106A determines that the pre-configured gap configuration is activated between the UE 102 and MN 104A upon receiving the in the SN Addition Request message in event 308E. After activating and/or deactivating the pre-configured gap pattern, the base station 104, UE 102 and SN 106A can perform the gap release procedure 394.

Referring now to FIG. 4A, which depicts a scenario 400A similar to the scenarios 300A, 300C and 300D. The differences between the scenarios 400A and the scenarios 300A, 300C, and 300D are discussed below.

In the scenario 400A, the UE 102 initially operates 402 in DC with the MN 104A and SN 106A. The MN 104A determines to configure a pre-configured gap configuration for the UE operating in DC. In response to the determination, the MN 104A transmits 404 a RRC reconfiguration message (e.g., RRCReconfiguration message) including a pre-configured gap configuration to the UE 102 to configure a pre-configured gap pattern for the UE 102, similar to event 304. In response, the UE 102 transmits a RRC reconfiguration complete message to the MN 104A, similar to event 306. Unlike the scenarios 300A, 300C or 300D, the MN 104A in this scenario does not configure the pre-configured gap configuration during a SN Addition or Change procedure that the MN 104A performed to configure the UE in DC with the MN 104A and SN 106A.

After configuring the pre-configured gap configuration for the UE 102, the MN 104A can transmit 408A a SN Modification Request message to the SN 106A. In some implementations, the MN 104A includes the pre-configured gap configuration and indicates the pre-configured gap configuration is deactivated in the SN Modification Request message, similar to event 308A or 336. In other implementations, the MN 104A does not include the preconfigured gap configuration and any information related to the pre-configured gap configuration in the SN Modification Request message, similar to event 308C. In response to the SN Modification Request message, the SN 106A transmits 410 a SN Modification Request Acknowledge message to the MN 104A. In some implementations, the SN 106A includes a SN configuration in the SN Modification Request Acknowledge message, similar to event 310. In such implementations, the MN 104A transmits a RRC reconfiguration message including the SN configuration to the UE 102 and receives a RRC reconfiguration complete message from the UE 102, similar to events 312 and 314, respectively. In other implementations, the SN 106A does not include a SN configuration in the SN Modification Request Acknowledge message, similar to event 338. In some implementations, event 408A can occur before event 404.

At a later time, the MN 104A, UE 102 and SN 106A can perform a gap activation procedure 490 or 491, similar to procedure 390 or 391. After performing the gap activation procedure, the MN 104A, UE 102 and SN 106A can perform a gap deactivation procedure 492 or 493, similar to procedure 392 or 393. In some implementations, after performing the gap deactivation procedure, the MN 104A, UE 102 and SN 106A can perform a gap release procedure 494, similar to procedure 394. In other implementations, after performing the gap activation procedure, the MN 104A, UE 102 and SN 106A can perform the gap release procedure 494, without perform the gap deactivation procedure.

Referring next to FIG. 4B, a scenario 400B is generally similar to the scenarios 400A and 300B. The differences between the scenario 400B and the scenarios 400A and 300B are discussed below.

In response to determining to configure a pre-configured gap configuration for the UE operating in DC, the MN 104A transmits 405 a RRC reconfiguration message (e.g., RRCReconfiguration message) including a pre-configured gap configuration to the UE 102 to configure a pre-configured gap pattern for the UE 102, similar to events 404 and/or 305. After configuring the pre-configured gap configuration for the UE 102, the MN 104A can transmit 408B a SN Modification Request message to the SN 106A, similar to events 408A and 308B.

The SN 106A refrains 430 from scheduling or transmitting DL transmissions for the UE 102 and/or scheduling UL transmissions within gaps in the pre-configured gap pattern, similar to event 330. In some implementations, event 408B occurs before event 405.

Referring next to FIG. 4C, a scenario 400C is generally similar to the scenarios 400A, 400B and 300E. The differences between the scenario 400C and the scenarios 400A, 400B and 300E are discussed below.

In the scenario 400C, the MN 104A transmits 403 to the UE a RRC reconfiguration message including the pre-configured gap configuration, similar to event 404 or 405. After configuring the pre-configured gap configuration for the UE 102, the MN 104A can transmit 408C a SN Modification Request message to the SN 106A, similar to events 408A, 408B and/or 308E. In some implementations, event 408C can occur before event 403.

After configuring the pre-configured gap configuration for the UE 102, the MN 104A can transmit 422 to the UE 102 an activation command to activate the pre-configured gap pattern, similar to event 322. The UE 102 can transmit a first ACK to the MN 104A to acknowledge reception of the activation command, similar to event 324. After activating the pre-configured gap pattern, the MN 104A can transmit 432 to the UE 102 a deactivation command to deactivate the pre-configured gap pattern, similar to event 332. The UE 102 can transmit a second ACK to the MN 104A to acknowledge reception of the deactivation command, similar to event 334. After activating and/or deactivating the pre-configured gap pattern, the base station 104, UE 102 and SN 106A can perform the gap release procedure 494, similar to procedure 394.

Referring now to FIG. 5, in a scenario 500, the MN 104A configures a network controlled small gap (NCSG) configuration for the UE 102, similar to the scenarios 300A-400C. Events 502, 504, 506, 508, 510, 512, 514, 516, 518, 520, 530, 533, 535, 537, 538, and 540 are similar to events 302/402, 303/304/305/403/404/405, 306/406, 308A/308B/308C/308E/408A/408B/408C, 310/410, 312, 314, 318, 318, 320, 330, 333, 335, 337, 338, and 340, respectively. Thus, the descriptions for the events in the scenarios 300A-400C can apply to the scenario 500. The descriptions related to the pre-configured gap configuration in the scenarios 300A-400C can apply to the NCSG configuration. The differences between the scenario 500 and the scenarios 300A-400C are described below.

While communicating with the UE 102 operating in SC or DC, the MN 104A determines to configure a NCSG configuration for the UE 102. In response to the determination, the MN 104A transmits 504 a RRC reconfiguration message (e.g., RRCReconfiguration message) including a NCSG configuration to the UE 102. After configuring the NCSG configuration, the MN 104A transmits 508 a SN Request message including the NCSG configuration to the SN 106A. In response, the SN 106A transmits 510 a SN Request Acknowledge message to the MN 104A. In some implementations, the SN Request message and SN Request Acknowledge message are SN Addition Request message and SN Addition Request Acknowledge message, respectively. In other implementations, the SN Request message and SN Request Acknowledge message are SN Modification Request message and SN Modification Request Acknowledge message, respectively.

Unlike the pre-configured gap configuration in the scenarios 300A and 400A, the NCSG pattern is activated by default. That is, there is no deactivation status for a NCSG pattern once the NCSG pattern is configured. The MN 104A does not include the activated or deactivated status for the NCSG configuration or pattern in the RRC reconfiguration message and SN Request message in events 504 and 508, respectively. Thus, the SN 106A may refrain 530 from scheduling or transmitting DL transmissions for the UE 102 and/or scheduling UL transmissions within gaps in the NCSG pattern after receiving the NCSG configuration in the SN Request message.

Referring now to FIG. 6, the MN 104A in a scenario 600 configures a list of gap configuration(s) for the UE 102, similar to the scenarios 300A-400C and 500. The differences between the scenario 600 and the scenarios 300A-400C and 500 are described below. Events 602, 604, 606, 608, 610, 612, 614, 616, 618, 620, 630, 633, 635, 637, 638, and 640 are similar to events 302/402/502, 303/304/305/403/404/405/504, 306/406/506, 308A/308B/308C/308E/408A/408B/408C/508, 310/410/510, 312/512, 314/514, 318/516, 318/518, 320/520, 330/530, 333/533, 335/535, 337/537, 338/538, and 340/540, respectively.

Thus, the descriptions for the events in the scenarios 300A-400C and 500 can apply to the scenario 600. The descriptions related to the (activated) pre-configured gap configuration and NCSG configuration in the scenarios 300A-400C and 500 can apply to the list of gap configuration(s). The differences between the scenario 600 and the scenarios 300A-400C and 500 are described below.

While communicating with the UE 102 operating in SC or DC, the MN 104A determines to configure one or more gap configuration for the UE 102. In response to the determination, the MN 104A generates an addition and/or modification list including the gap configuration(s) and transmits 604 a RRC reconfiguration message (e.g., RRCReconfiguration message) to the UE 102. In some implementations, the gap configuration(s) include one or more pre-configured gap configurations, one or more NCSG configurations, and/or one or more other gap configurations than pre-configured gap configuration and NCSG configurations. In some implementations, the other gap configuration(s) configuring other gap pattern(s) and is/are activated by default. After configuring the NCSG configuration, the MN 104A transmits 608 a SN Request message including the addition and/or modification list to the SN 106A. In response, the SN 106A transmits 610 a SN Request Acknowledge message to the MN 104A.

If the addition and/or modification list includes NCSG configuration(s) or pattern(s) and/or other gap configuration(s), the MN 104A does not include the activated or deactivated status for the NCSG configuration(s) or pattern(s) and/or other gap configuration(s) in the RRC reconfiguration message and SN Request message in events 604 and 608, respectively. Thus, the SN 106A may refrain 630 from scheduling or transmitting DL transmissions for the UE 102 and/or scheduling UL transmissions within gaps in the NCSG pattern(s) and/or other gap pattern(s) after receiving the NCSG configuration in the SN Request message. If the addition and/or modification list includes pre-configured gap configuration(s), the SN 106A may refrain 630 from scheduling or transmitting DL transmissions for the UE 102 and/or scheduling UL transmissions within gaps in the pre-configured gap pattern(s) after receiving the pre-configured gap configuration in the SN Request message, as described for the scenarios 300A-400C.

At a later time, the MN 104A determines to release at least one (e.g., one, some or all) of the gap configuration(s). In response to the determination, the MN 104A can generate a release list to release the at least one gap configuration. The MN 104A then transmits 633 to the UE 102 a RRC reconfiguration message including the at least one gap configuration and transmits 637 to the SN 106A a SN Request message including the at least one gap configuration. The UE 102 releases the at least one gap configuration in response to the RRC reconfiguration message. The SN 106A releases the at least one gap configuration in response to the SN Request message, respectively. In some implementations, the MN 104A includes gap ID(s) of the at least one gap configuration in the release list. The UE 102 and SN 106A identifies the at least one gap configuration is released based on the gap ID(s) in the release list. The SN 106A may schedule 640 from scheduling or transmitting DL transmissions for the UE 102 and/or scheduling UL transmissions in slot(s) within gap pattern(s) that was configured in the at least one gap configuration.

In some implementations, the MN 104A can include the addition and/or modification list in a MeasGapConfig IE and include the MeasGapConfig IE in the RRC reconfiguration message and the SN Request message in events 612 and 616, respectively. In some implementations, the MN 104A can include the release list in a MeasGapConfig IE and include the MeasGapConfig IE in the RRC reconfiguration message and the SN Request message in event 633 and 637, respectively.

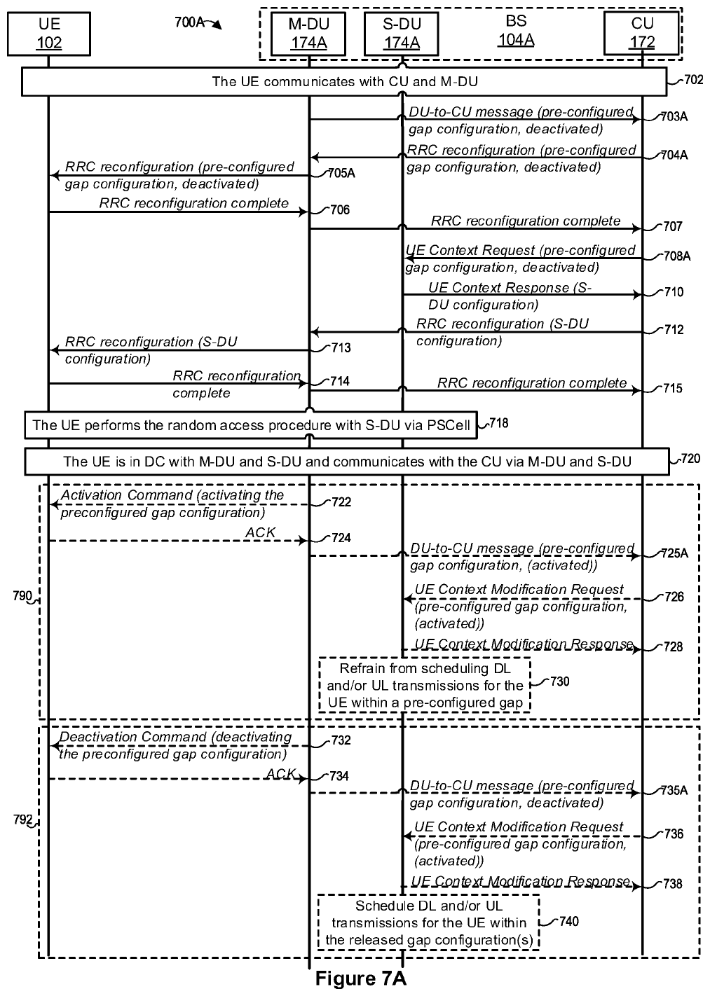

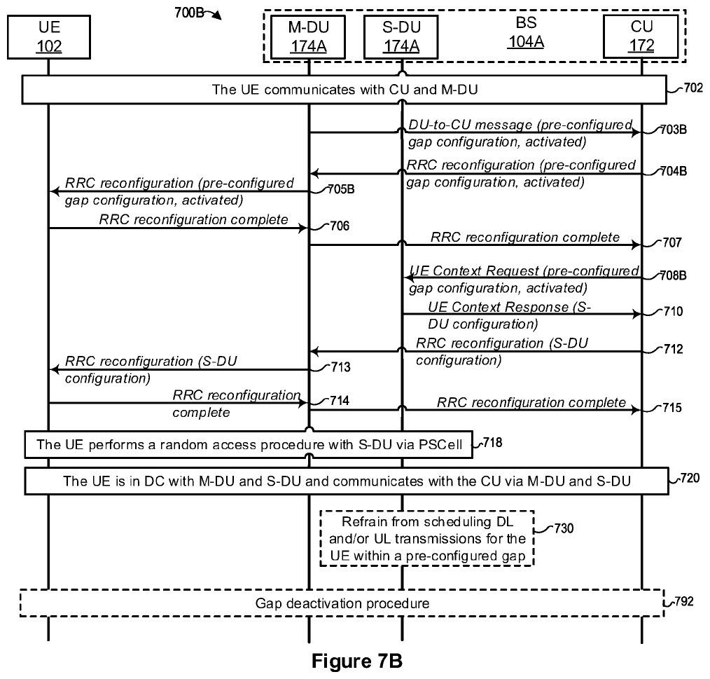

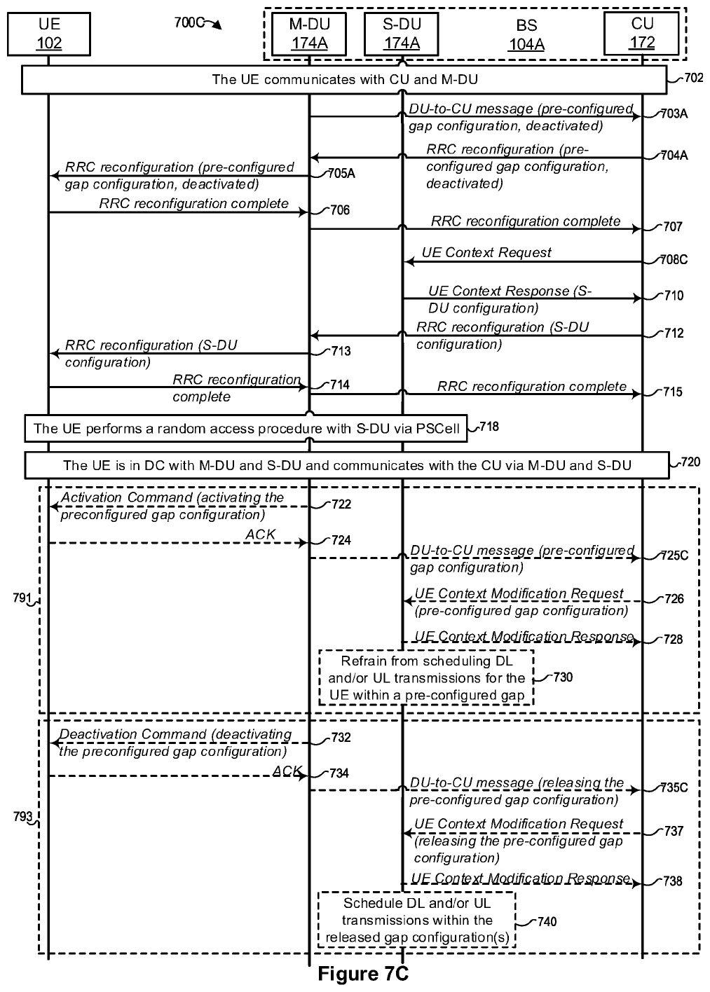

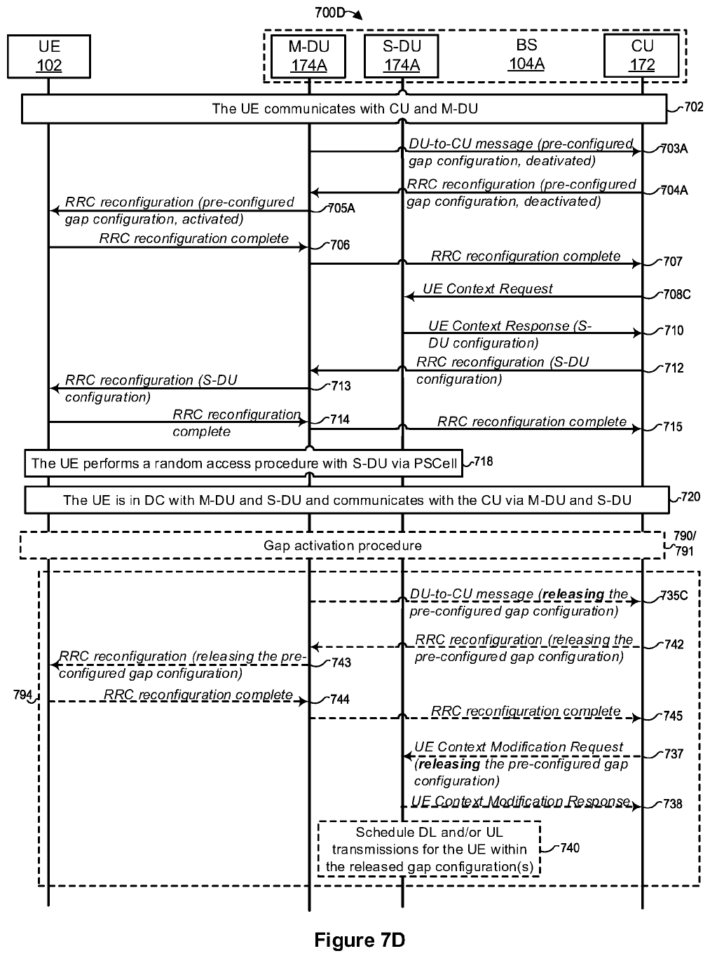

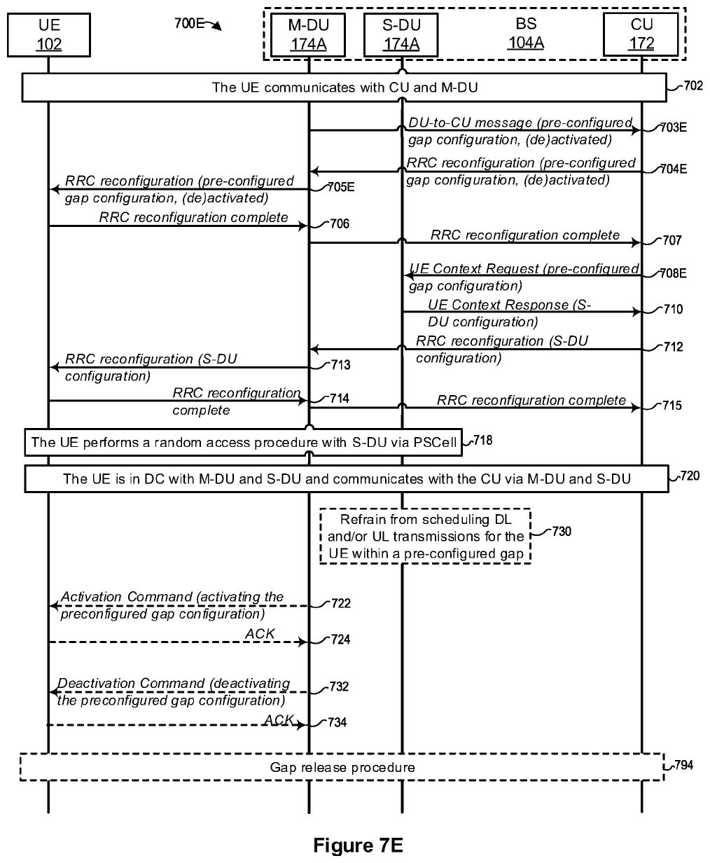

Referring now to FIG. 7A, a scenario 700A is generally similar to the scenario 300A, except that the base station 104A includes a CU 172, a master DU (M-DU) 174A (i.e., a DU 174A of the DU(s) 174) and a secondary DU (S-DU) 174B (i.e., a DU 174B of the DU(s) 174). The CU 172 and M-DU 174A are operated as a MN and the CU 172 and S-DU 174B are operated as a SN, similar the MN 104A and SN 106A described in the scenario 300A. Events 704A and 705A, 706 and 707, 712 and 713, 714 and 715, 718, 720, 722, 724, 730, 732, 734, 740 are similar to events 304, 306, 312, 314, 318, 320, 322, 324, 330, 332, 334, 340, respectively.

The differences between the scenario 700A and scenario 300A are described below.

In the scenario 700A, the UE 102 initially operates 702 in the connected state and communicate with the CU 172 and M-DU 174A. The M-DU 174A then transmits 703A a DU-to-CU message including a pre-configured gap configuration to the CU 172. In some implementations, the M-DU 174A receives a first CU-to-DU message from the CU 172 and transmits the DU-to-CU message in response to the first CU-to-DU message. In one implementation, the CU 172 includes measurement related information in the first CU-to-DU message and the DU 174 generates the pre-configured gap configuration based on the measurement related information. For example, the measurement related information includes reference signal configuration(s), measurement timing configuration(s) and/or information of measured frequency/frequencies. The reference signal configuration(s) configures location(s) of one or more reference signals to be measured. In another implementation, the CU 172 can include positioning reference signal information in the first CU-to-DU message. The positioning reference signal information includes a list of transmission and/or reception point ID(s), cell ID(s) and/or positioning reference signal configuration(s). The M-DU 174A generates the pre-configured gap configuration based on the positioning reference signal information. In some implementations, the DU-to-CU message is a UE Context Modification Required message, UE Context Modification Response or a Measurement Reconfiguration Confirm message. In some implementations, the first CU-to-DU messages can be a UE Context Modification Request message or a Measurement Reconfiguration Required message.

After receiving the pre-configured gap configuration from the M-DU 174A, the CU 172 generates an RRC reconfiguration including the pre-configured gap configuration and transmits 704A the RRC reconfiguration message to the M-DU 174A, which in turn transmits 705A the RRC reconfiguration message to the UE 102. In response, the UE 102 transmits 706 a RRC reconfiguration complete message to the M-DU 174A, which in turn transmits 707 the RRC reconfiguration complete message to the CU 172. In some implementations, the M-DU 174A generates a MeasGapConfig IE including the pre-configured gap configuration and includes the MeasGapConfig IE in the DU-to-CU message. The CU 172 includes the MeasGapConfig IE in the RRC reconfiguration message. In other implementations, the CU 172 generates a MeasGapConfig IE including the pre-configured gap configuration instead of the M-DU 174A and includes the MeasGapConfig IE in the RRC reconfiguration message.

In some implementations, the CU 174 includes, in the RRC reconfiguration message, a first indication indicating the preconfigured gap configuration (i.e., the preconfigured gap pattern) is deactivated (i.e., not activated yet), similar to event 304. In one implementation, the M-DU 174A includes a deactivation indication indicating the pre-configured gap configuration in the DU-to-CU message. Based on the deactivation indication, the CU 172 can determine that the pre-configured gap configuration is deactivated and generates the first indication in the RRC reconfiguration message. In other implementations, the M-DU 174A includes the first indication in the pre-configured gap configuration or MeasGapConfig IE. In such cases, the CU 172 does not generate the first indication. The CU 172 can decode the preconfigured gap configuration or MeasGapConfig IE to obtain the first indication, and determine that the pre-configured gap configuration is deactivated based on the first indication.

In yet other implementations, the M-DU 174A includes the first indication in a particular configuration other than the pre-configured gap configuration. For example, the configuration can be a BWP configuration, non-BWP configuration or cell group configuration (e.g., CellGroupConfig) and the M-DU 174A includes the configuration in the DU-to-CU message. The CU 172 decodes the configuration to obtain the first indication and determines that the pre-configured gap configuration is deactivated in accordance with the first indication.

In yet other implementations, the M-DU 174A does not include an indication indicating the pre-configured gap configuration is deactivated in the DU-to-CU message, and the preconfigured gap configuration is configured and initially deactivated by default, e.g., which can be defined in a 3GPP specification. Thus, the UE 102, M-DU 174A and/or CU 172 determines the pre-configured gap configuration is deactivated when the pre-configured gap configuration is initially configured.

After event 703A, 704A or 705A, the CU 172 determines to configure DC for the UE 102. In response to the determination, the CU 172 transmits 708A a UE Context Setup Request message including the pre-configured gap configuration or MeasGapConfig IE to the S-DU 174B, similar to event 308A. In response, the M-DU 174A transmits 710 a UE Context Response message including an S-DU configuration to the CU 172, similar to event 310. The examples and implementations for the SN configuration can apply to the S-DU configuration. In some implementations, the UE Context Request message and UE Context Response message can be a UE Context Setup Request message and a UE Context Setup Response message. In other implementations, the UE Context Request message and UE Context Response message can be a UE Context Modification Request message and a UE Context Modification Response message.

In some implementations, the CU 172 includes the pre-configured gap configuration in a container (e.g., an RRC inter-node IE such as a CG-ConfigInfo IE) and includes the container in the UE Context Request message. In one implementation, the MN 104A includes the pre-configured gap configuration in a configuration list, includes the configuration list in a MeasGapConfig IE, includes the MeasGapConfig IE in a container (e.g., an RRC inter-node IE such as a CG-ConfigInfo IE) and includes the container in the UE Context Request message. In another implementation, the MN 104A includes the pre-configured gap configuration in a configuration list, includes the configuration list in a container (e.g., an RRC inter-node IE such as a CG-ConfigInfo IE) without wrapping the configuration list in a MeasGapConfig IE, and includes the container in the UE Context Request message. In some implementation, the configuration list is a gapToAddModList(-r17) IE. In other implementations, the configuration list is a PosMeasGapPreConfigToAddModList-r17 IE.

In other implementations, the CU 172 includes the pre-configured gap configuration in a first IE of the UE Context Request message instead of using an RRC inter-node IE. In some implementations, the CU 172 can include a second indication indicating the preconfigured gap configuration is deactivated in the SN Addition Request message. In one implementation, the CU 172 includes the second indication in the container, MeasGapConfig IE or configuration list that are included in the UE Context Request message. In other implementations, the CU 172 includes the second indication in the first IE or a second IE of the UE Context Request message. In some implementations, the MeasGapConfig IE included in the UE Context Request message and the MeasGapConfig IE included in the RRC reconfiguration message can be the same. In other implementations, the MeasGapConfig IE included in the UE Context Request message and the MeasGapConfig IE included in the RRC reconfiguration message can be different.

After receiving the S-DU configuration, the CU 172 transmits 712, 713 a RRC reconfiguration message including the S-DU configuration to the UE 102 via the M-DU 174A, similar to event 312. In response, the UE 102 transmits 714, 715 a RRC reconfiguration complete message to the CU 172 via the M-DU 174A, similar to event 314. The UE 102 performs 718 a random access procedure with the S-DU 174B in response to receiving the S-DU configuration. After successfully completing the random access procedure, the UE 102 operates 720 in DC with the M-DU 174A and S-DU 174B and communicates with the CU 172 via the M-DU 174A and S-DU 174B. While communicating with the UE 102 in DC with the M-DU 174A and S-DU 174B, the M-DU 174A can transmit 722 to the UE 102 an activation command activating the (deactivated) pre-configured gap configuration, similar to event 322. The M-DU 174A can receive 724 a first ACK from the UE 102, similar to event 324.

In some implementations, the M-DU 174A activates the pre-configured gap configuration in response to receiving a second CU-to-DU message from the CU 172. For example, the CU 172 sends the second CU-to-DU message to request the M-DU 174A to activate the pre-configured gap configuration for the UE 102. In some implementations, the second CU-to-DU messages can be a UE Context Modification Request message or a Measurement Activation message (e.g., including an activation indication). In other implementations, the M-DU 174A activates the pre-configured gap configuration in response to receiving an activation request message from the UE 102. In some implementations, the activation request message is a UL MAC CE. In yet other implementations, the M-DU 174A activates the pre-configured gap in response to adding a new SCell or changing an active BWP for the UE 102.

After activating the pre-configured gap pattern for the UE 102, the M-DU 174A can transmit 725A a DU-to-CU message to the CU 172 to indicate that the pre-configured gap configuration is activated. In some implementations, the M-DU 174A includes the pre-configured gap configuration in the DU-to-CU message. In other implementations, the M-DU 174A includes the gap ID of the pre-configured gap configuration in the DU-to-CU message. In some implementations, the M-DU 174A includes an activation indication or excludes a deactivation indication in the DU-to-CU message to indicate that the pre-configured gap configuration is activated. Thus, the CU 172 can determine that the pre-configured gap configuration is activated based on the activation indication or exclusion of the deactivation indication.

After (e.g., in response to) receiving the DU-to-CU message in event 725A, the CU 172 transmits 726 a UE Context Modification Request message to the S-DU 174B. In some implementation, the CU 172 includes, in the UE Context Modification Request message, the pre-configured gap configuration and an activation indication indicating the pre-configured gap configuration is activated. In some implementations, the CU 172 includes the pre-configured gap configuration in a container (e.g., an RRC inter-node IE such as a CG-Config IE) and includes the container in the UE Context Modification Request message. In one implementation, the CU 172 includes the pre-configured gap configuration in a configuration list, includes the configuration list in a MeasGapConfig IE, includes the MeasGapConfig IE in a container (e.g., an RRC inter-node IE such as a CG-ConfigInfo IE) and includes the container in the UE Context Modification Request message. In another implementation, the CU 172 includes the pre-configured gap configuration in a configuration list, and includes the configuration list in a container (e.g., an RRC inter-node IE such as a CG-ConfigInfo IE) without using a MeasGapConfig IE to wrap the pre-configured gap configuration, and includes the container in the UE Context Modification Request message. In other implementations, the CU 172 includes the pre-configured gap configuration in a first IE of the UE Context Modification Request message instead of using an RRC inter-node IE. Depending on the implementations, the CU 172 includes the activation indication in the pre-configured gap configuration, the configuration list, MeasGapConfig IE, the container, the first IE, or a second IE of the UE Context Modification Request message. In other implementations, the CU 172 includes, in the UE Context Modification Request message, the gap ID of the pre-configured gap configuration or pattern instead of including the whole pre-configured gap configuration. Thus, the S-DU 174B can use the gap ID to identify the pre-configured gap configuration that the S-DU 174B received in event 708A. If the CU 172 includes the gap ID in an activation list (i.e., the name of the list indicates activation status), the CU 172 may not include the activation indication in the UE Context Modification Request message. In some implementations, the MN 104A can include the activation list in the container.

In some alternative implementations, the M-DU 174A transmits the DU-to-CU message of event 725A before transmitting the activation command of event 722 to the UE 102.

In response to the UE Context Modification Request message of event 726 or the activation indication, the S-DU 174B may refrain 730 from scheduling or transmitting DL transmissions for the UE 102 and/or scheduling UL transmissions within gaps in the pre-configured gap pattern. In some implementations, the DL transmissions include CSI reference signal (CSI-RS), DCIs on PDCCH(s), and/or PDSCH transmission(s). In some implementations, the UL transmissions include PUSCH transmissions, SRS and/or CSI. In some implementations, the S-DU 174B performs gap coordination with the M-DU 174A based on the pre-configured gap pattern, in response to the UE Context Modification Request message of event 726 or the activation indication. If the S-DU 174B determines to configure a gap pattern (i.e., SN configured gap pattern) for the UE 102, the S-DU 174B aligns the SN configured gap pattern with the pre-configured gap pattern or make the SN configured gap pattern and the pre-configured gap pattern overlap. In some implementations, the S-DU 174B overlaps the SN-configured gap pattern and the pre-configured gap pattern as much as possible to save UE 102 power and/or meet UE 102 measurement needs. In some implementations, the S-DU 174B generates a SN gap configuration (re)configuring the SN-configured gap pattern and transmit a DU-to-CU message including the SN gap configuration to the CU 172. The CU 172 generates an RRC reconfiguration message including the SN gap configuration to UE 102, and transmits the RRC reconfiguration message to the UE 102 via the M-SD 174A and SRB1) or via S-DU 174B and SRB3 (if the SRB3 is configured). The UE 102 uses the SN-configured gap pattern to perform measurements configured by the CU 172.

The events 722, 724, 725A, 726, 728, and 730 are collectively referred to in FIG. 3A as a gap activation procedure 790.

At a later time, the M-DU 174A transmits 732 a deactivation command to the UE 102 to deactivate the pre-configured gap configuration, similar to event 332. The UE 102 can transmit 734 a second ACK to acknowledge reception of the deactivation command, similar to event 334. In some implementations, the M-DU 174A deactivates the pre-configured gap configuration in response to receiving a third CU-to-DU message from the CU 172. In some implementations, the third CU-to-DU message requests the M-DU 174B to deactivate the pre-configured gap configuration. In some implementations, the third CU-to-DU messages can be a UE Context Modification Request message, a Measurement Activation message (e.g., including a deactivation indication) or a Measurement Deactivation message. In other implementations, the M-DU 174A receives a deactivation request message from the UE 102 to request to deactivate the (activated) pre-configured gap configuration. The M-DU 174A deactivates the pre-configured gap configuration in response to the activation request message. In some implementations, the deactivation request message can be a UL MAC CE. In yet other implementations, the M-DU 174A activates the pre-configured gap in response to releasing a SCell or changing an active BWP for the UE 102.

After (e.g., in response to) deactivating the pre-configured gap pattern, the M-DU 174A can transmit 735A to the CU 172 a DU-to-CU message indicating that the pre-configured gap configuration is deactivated. In some implementations, the M-DU 174A includes the pre-configured gap configuration in the DU-to-CU message. In other implementations, the M-DU 174A includes the gap ID of the pre-configured gap configuration in the DU-to-CU message. In some implementations, the M-DU 174A includes a deactivation indication or excludes an activation indication in the DU-to-CU message to indicate that the pre-configured gap configuration is deactivated. Thus, the CU 172 can determine that the pre-configured gap configuration is activated based on the deactivation indication or exclusion of the activation indication.

After receiving the DU-to-CU message in event 735A, the CU 172 can transmit 736 a UE Context Modification Request message to the S-DU 174B, similar to event 336. In response, the S-DU 174B transmits 738 a UE Context Modification Response message to the CU 172. In some implementations, the CU 172 indicates the pre-configured gap configuration is deactivated in the UE Context Modification Request message of event 736, similar to event 708A.

In other implementations, the MN 104A includes, in the UE Context Modification Request message in event 736, the gap ID of the pre-configured gap configuration or pattern instead of including the whole pre-configured gap configuration. Thus, the S-DU 174B can use the gap ID to identify the pre-configured gap configuration that the S-DU 174B received in event 708A. If the CU 172 includes the gap ID in a deactivation list (i.e., the name of the list indicates deactivation status), the CU 172 may not include the deactivation indication in the UE Context Modification Request message of event 736. In some implementations, the CU 172 includes the deactivation list in the container.

In some alternative implementations, the M-DU 174A transmits the DU-to-CU message of event 735A before transmitting the activation command of event 732 to the UE 102.

In response to the UE Context Modification Request message of event 736 or the deactivation indication, in the UE Context Modification Request message, indicating the preconfigured gap configuration is deactivated, the S-DU 174B can schedule 740 DL and/or UL transmissions for the UE 102 within gaps in the pre-configured gap pattern. After (e.g., in response to) receiving the UE Context Modification Request message of event 736 or the deactivation indication, the S-DU 174B stops or refrains from performing gap coordination based on the pre-configured gap configuration.

The events 732, 734, 735A, 736, 738, and 740 are collectively referred to in FIG. 7A as a gap deactivation procedure 792.

Referring now to FIG. 7B, a scenario 700B is generally similar to the scenarios 300B and 700A. Events 704B and 705B are similar to events 305. Events 703B, 704B, 705B, and 708B are similar to events 703A, 704A, 705A, and 708A, respectively, except that the pre-configured gap configuration in events 703B, 704B, 705B and 708B is activated. Event 708B is also similar to event 308B, except that the message of event 708B is transmitted from the CU 172 to the M-DU 174A, and the message of event 308B is transmitted from the MN 104A to the SN 106A.

FIG. 7C illustrates a scenario 700C, which is generally similar to the scenarios 300C, 700A and 700B. Event 708C is similar to events 708A and 708B, except that the message of event 708C does not include a pre-configured gap configuration. Event 708C is also similar to event 300C, except that the message of event 708C is transmitted from the CU 172 to the M-DU 174A, and the message of event 308C is transmitted from the MN 104A to the SN 106A. Event 725C is similar to event 725A, except that the message of event 725C does not indicate or include the status (i.e., activated or deactivated) of the pre-configured gap configuration.

Event 735C is similar to event 735A, except that the message of event 735C indicates releasing the pre-configured gap configuration, and the message of event 735A indicates that the pre-configured gap configuration is deactivated. In some implementations, the M-DU 174A includes a release list including the gap ID of the pre-configured gap to indicate the CU 172 that the pre-configured gap configuration is released. Thus, the M-DU 174A does not include the pre-configured gap configuration in the UE Context Modification Request message in event 735C. In some implementations, the release list is gapToReleaseList-r17. In other implementations, the release list is a posMeasGapPreConfigToReleaseList-r17.

Event 737 is similar to event 736, except that the message of event 737 indicates releasing the pre-configured gap configuration, and the message of event 736 indicates that the pre-configured gap configuration is deactivated. Event 737 is also similar to event 337, except that the message of event 737 is transmitted from the CU 172 to the M-DU 174A, and the message of event 337 is transmitted from the MN 104A to the SN 106A. In some implementations, the CU 172 includes a release list including the gap ID of the pre-configured gap to indicate the S-DU 174B that the pre-configured gap configuration is released. Thus, the S-DU 174A does not include the pre-configured gap configuration in the UE Context Modification Request message in event 737. In some implementations, the release list is gapToReleaseList-r17. In other implementations, the release list is a posMeasGapPreConfigToReleaseList-r17.

The events 722, 724, 725C, 726, 728, and 730 are collectively referred to in FIG. 7C as a gap activation procedure 791. The events 732, 734, 735C, 737, 738, and 740 are collectively referred to in FIG. 7C as a gap deactivation procedure 793.

Now referring to FIG. 7D, a scenario 700D is generally similar to the scenarios 300D and 700A-C. Events 742 and 743, and events 744 and 745 are similar to events 333 and 335, respectively.

The events 735C, 742, 743, 744, 745, 737, 738, and 740 are collectively referred to in FIG. 7D as a gap release procedure 794.

Next, FIG. 7E illustrates a scenario 700E, which is generally similar to the scenarios 300E and 700A-D. Events 742 and 743, and events 744 and 745 are similar to events 333 and 335, respectively. Events 703E and 704E are similar to events 703A/703B and 704A/704B, respectively. Event 708E is similar to event 708A or 708B, except that, the message of event 708E does not indicate or include the status (i.e., activated or deactivated) of the pre-configured gap configuration. Event 708E is also similar to event 308E, except that the message of event 708E is transmitted from the CU 172 to the M-DU 174A, and the message of event 308E is transmitted from the MN 104A to the SN 106A.

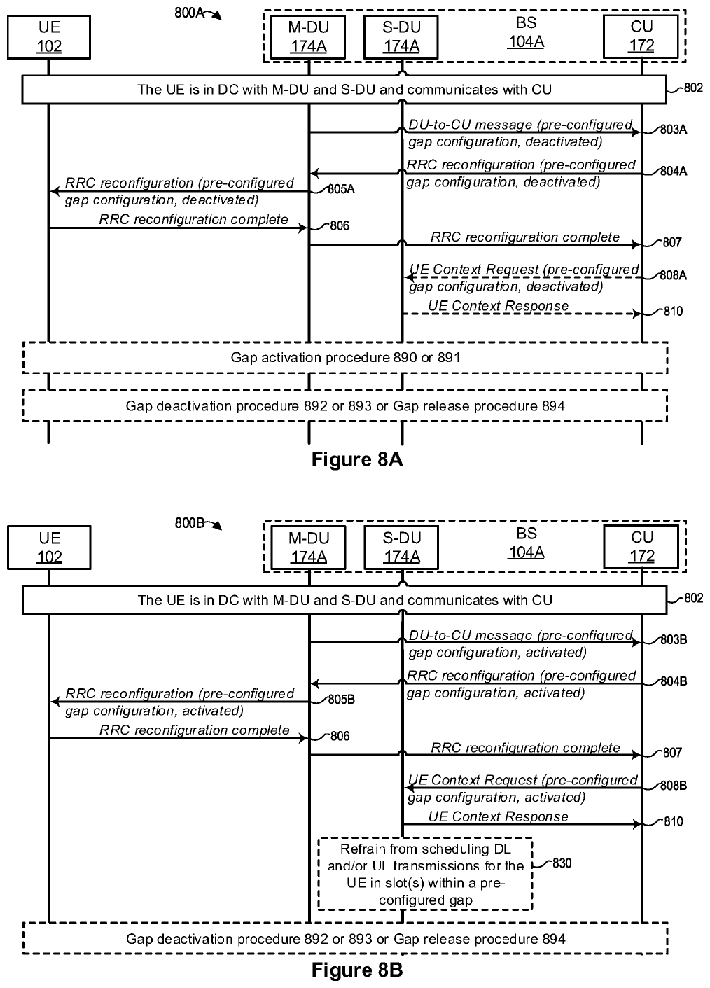

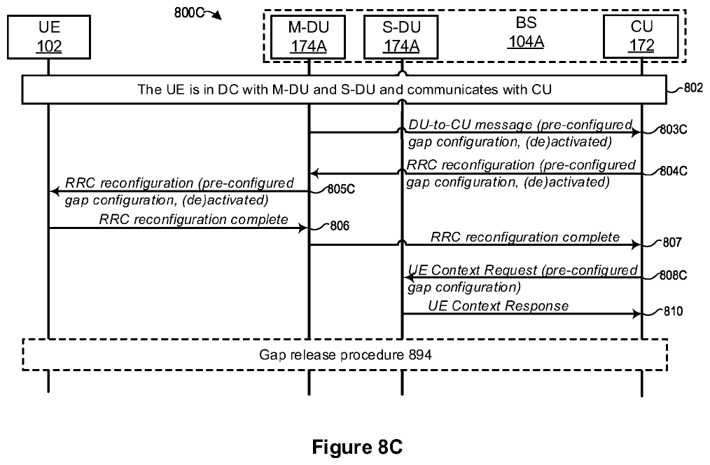

Referring now to FIG. 8A, a scenario 800A is generally similar to the scenarios 700A, 700C, 700D and 400A.

In the scenario 700A, the UE 102 initially operates 802 in the connected state, communicates with and the M-DU 174A and S-DU 174B in DC and communicates with the CU 172 via the M-DU 174A and S-DU 174B. While communicating with the UE 102 operating in DC, the M-DU 174A transmits 803A a DU-to-CU message to the CU 172, similar to event 703A. After receiving the DU-to-CU message, the CU 172 transmits 804A, 805A a RRC reconfiguration message to the UE via the M-DU 174A, similar to events 704A and 705A. In response, the UE 102 transmits 806, 807 a RRC reconfiguration complete message to the CU 172 via the M-DU 174A, similar to events 705 and 706. In some implementations, the CU 172 transmits 808A a UE Context Request message to the S-DU 174B, similar to event 708A. In response, the S-DU 174B transmits 810 a UE Context Response message to the CU 172, similar to event 710. In other implementations, the CU 172 does not send the deactivated pre-configured gap configuration to the S-DU 174B. In such implementations, event 808A and 810 can be skipped. The base station 104A and UE 102 then can perform a gap activation procedure 890 or 891 to activate the pre-configured gap configuration, similar to procedure 790 or 791.

After activating the pre-configured gap configuration, the base station 104A and UE 102 can perform a gap deactivation procedure 892 or 893, similar to procedure 792 or 793. In some implementations, after performing the gap deactivation procedure, the base station 104A and UE 102 can perform a gap release procedure 894, similar to procedure 794. In other implementations, after performing the gap activation procedure, the base station 104A and UE 102 can perform the gap release procedure 894, without perform the gap deactivation procedure.

Referring now to FIG. 8B, a scenario 800B is generally similar to the scenarios 800A, 700B and 400B. Events 803B, 804B, 805B and 808B are similar to events 703B, 704B, 705B and 708B, respectively. Events 804B and 805B are similar to event 405.

FIG. 8C depicts a scenario 800C similar to the scenarios 800A, 800B, 700E and 400C. Events 803C, 804C, 805C and 808C are similar to events 703E, 704E, 705E and 708E, respectively. Events 804C and 805C are similar to event 303.

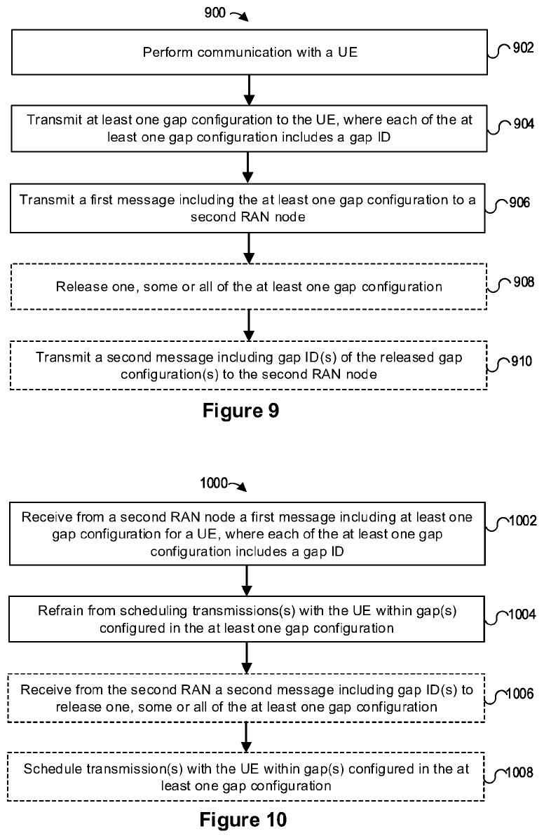

Next, several example methods that can be implemented in a RAN node such as a BS, a DU of a BS, or a CU of a BS are discussed with reference to FIGS. 9-12. Each of these methods can be implemented using processing hardware such as one or more processors to execute instructions stored on a non-transitory computer-readable medium such as computer memory.

Referring first to FIG. 9, a method 900 can be implemented in a first RAN node (e.g., RAN 105, base station 104, CU 172 or DU 174) and includes sending gap configuration(s) for a UE (e.g., UE 102) to a second RAN node and optionally notifying the second RAN node of the gap configuration(s) is released when the gap configuration(s) is released.

The method 900 begins at block 902, the first RAN node performs communication with the UE (e.g., events 302, 402. 502, 602, 702, 802). At block 904, the first RAN node transmits at least one gap configuration to the UE, where each of the at least one gap configuration includes a gap ID (e.g., events 304, 305, 303, 404, 405, 403, 504, 604, 704A, 705A, 704B, 705B, 704E, 705E, 804A, 805A, 804B, 805B, 804C, 805C). In some implementations, the first RAN node assigns each of the gap ID(s). At block 906, the first RAN node transmits a first message including the at least one gap configuration to a second RAN node (e.g., events 308A, 308B, 308E, 326, 327, 390, 391, 408A, 408B, 408C, 490, 491, 508, 608, 703A, 703B, 703C, 708A, 708B, 708E, 725A, 725B, 725, 726, 790, 791, 808A, 808B, 808C, 890, and 891). At block 908, the first RAN node deactivates or releases one, some, or all of the at least one gap configuration. At block 910, the first RAN node transmits a second message including gap ID(s) of the deactivated or released gap configuration(s) to the second RAN node (e.g., events 336, 337, 392, 393, 394, 492, 493, 494, 537, 637, 735A, 735C, 736, 737, 792, 793, 794, 892, 893, and 894).

In some implementations, the first RAN node is a MN (e.g., the MN 104A) and the second RAN node is a SN (e.g., the SN 106A). In other implementations, the first RAN node is a CU (e.g., the CU 172) and the second RAN node is a DU (e.g., S-DU 174B). In yet other implementations, the first RAN node is a DU (e.g., M-DU 174A) and the second RAN node is a CU (e.g., CU 172).

In some implementations, the first RAN node at block 906 can generate a configuration list or addition and modification list including the at least one gap configuration and transmits the configuration list or addition and modification list to the second RAN node. In some implementations, the first RAN node at block 906 can generate a release list including the gap ID(s) of the deactivated or released gap configuration(s) and transmits the release list to the second RAN node.

Referring next to FIG. 10, a method 1000 can be implemented in a first RAN node avoid scheduling DL and/or UL transmissions with a UE (e.g., UE 102) within gap(s) configured by a second RAN node.

The method 1000 begins at block 1002, where the first RAN node receives from a second RAN node a first message including at least one gap configuration for a UE, where each of the at least one gap configuration includes a gap ID (e.g., events 304, 305, 303, 404, 405, 403, 504, 604, 704A, 705A, 704B, 705B, 704E, 705E, 804A, 805A, 804B, 805B, 804C, 805C). At block 1004, the first RAN node refrains from scheduling transmissions(s) with the UE within gap(s) configured in the at least one gap configuration (e.g. 330, 390, 391, 430, 490, 491, 530, 630, 730, 790, 792, 830, 890, 891). At block 1006, the first RAN node receives from the second RAN a second message including gap ID(s) to release one, some or all of the at least one gap configuration (e.g., events 336, 337, 392, 393, 394, 492, 493, 494, 537, 637, 735A, 735C, 736, 737, 792, 793, 794, 892, 893, and 894). At block 1008, the first RAN node schedules transmission(s) with the UE within gap(s) configured in the at least one gap configuration (e.g., 340, 392, 393, 394, 492, 493, 494, 540, 640, 740, 792, 793, 794, 892, 893, 894).

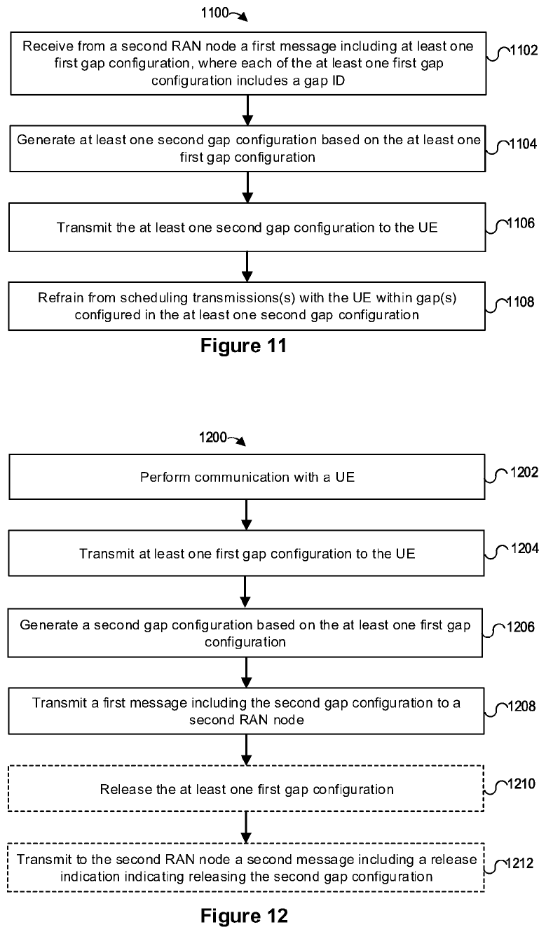

Referring next to FIG. 11, a method 1100 can be implemented in a first RAN node avoid scheduling DL and/or UL transmissions with a UE (e.g., UE 102) within gap(s) configured by a second RAN node.

The method 1100 begins at block 1102, where the first RAN node receives from a second RAN node a first message including at least one gap configuration for a UE, where each of the at least one gap configuration includes a gap ID (e.g., events 304, 305, 303, 404, 405, 403, 504, 604, 704A, 705A, 704B, 705B, 704E, 705E, 804A, 805A, 804B, 805B, 804C, 805C). At block 1104, the first RAN node generates at least one second gap configuration based on the at least one first gap configuration. At block 1106, the first RAN node transmits the at least one second gap configuration to the UE. At block 1108, the first RAN node refrains from scheduling transmissions(s) with the UE within gap(s) configured in the at least one second gap configuration.

The first RAN node and second RAN node in FIGS. 10 and 11 are the first RAN node and second RAN node in FIG. 9, respectively. At least some of the techniques discussed in connection with the first RAN node and the second RAN node in FIG. 9 can also apply to FIGS. 9-11.

In some implementations, the transmission(s) include DL transmission(s) and/or UL transmission(s). In some implementations, the first RAN node includes the at least one gap configuration in a first container and includes the first container (e.g., a list container) in the first message at block 906. That is, the first message includes the first container including the at least one gap configuration in blocks 1002 and 1102.

In cases where the first RAN node is a CU, the CU communicates with the UE via a DU and receives the at least one gap configuration from the DU. In some implementations, the first message is a SN Addition Request message or a SN Modification Request message. In some implementations, the second message is a SN Modification Request message. In other implementations, the first message and second message are CG-ConfigInfo IE.

In some implementations, the at least one gap configuration includes preconfigured gap configuration(s), NCSG configuration(s), or concurrent gap configuration(s), and/or legacy gap configuration(s). In one implementation, the preconfigured gap configuration(s), NCSG configuration(s), and concurrent gap configuration(s) is/are defined in 3GPP specifications 38.331 and 38.133 Release 17 and/or later release(s) and the legacy configuration(s) is/are defined in 3GPP specifications 38.331 and 38.133 Release 15 and later release(s).

In some implementations, each of the at least one gap configuration is a GapConfg-r17 IE defined in 3GPP specification 17.1.0 and/or later versions. In some implementations, the first container is a list IE/field (e.g., “SEQUENCE (SIZE (1. maxNrofGapId-r17)) OF GapConfig-r17”, PosMeasGapPreConfigToAddModList-r17, posMeasGapPreConfigToAddModList-r17, or gapToAddModList-r17). In some implementations, the gap ID is a measGapId-r17 or MeasGapId-r17 field/IE. In other implementations, the first container is a measGapConfig or MeasGapConfig field/IE.

In some implementations, the first RAN node includes the first container in a first additional container and includes the first additional container in the first message at block 906. That is, the first message includes the first additional container which includes the first container including at least one gap configuration in blocks 1002 and 1102. In one implementation, the first additional container is a measGapConfig or MeasGapConfig field/IE. In another implementation, the first additional container is a MeasConfigMN IE.

In some implementations, the first RAN node includes the ID(s) in a second container (e.g., a list container). In some implementations, second container is a gapToReleaseList-r17, “SEQUENCE (SIZE (1. . . maxNrofGapId-r17)) OF MeasGapId-r17”, measPosPreConfigGapId-r17, or MeasPosPreConfigGapId-r17. In some implementations, the second container is a measGapConfig or MeasGapConfig field/IE.

In some implementations, the first RAN node includes the second container in a second additional container and includes the second additional container in the second message. That is, the second message includes the second additional container which includes the second container including the ID(s) in blocks 1006. In one implementation, the second additional container is a measGapConfig or MeasGapConfig field/IE. In another implementation, the second additional container is a MeasConfigMN IE.

In some implementations, if there is/are gap configuration(s) not released by the second message, the second RAN node refrains from scheduling transmissions(s) to the UE within gap(s) configured in the unreleased gap configuration(s).

Referring next to FIG. 12, a method 1200 can be implemented in a first RAN node to transmit a gap configuration for a UE (e.g., UE 102) to a second RAN node.

The method 1200 begins at block 1302, the first RAN node performs communication with the UE (e.g., events 302, 402. 502, 602, 702, 802). At block 1204, the first RAN node transmits at least one first gap configuration to the UE. (e.g., events 304, 305, 303, 404, 405, 403, 504, 604, 704A, 705A, 704B, 705B, 704E, 705E, 804A, 805A, 804B, 805B, 804C, 805C). At block 1206, the first RAN generates a second gap configuration based on the at least one first gap configuration. At block 1208, the first RAN node transmits a first message including the second gap configuration to the second RAN node. At block 1210, the first RAN node releases the at least one first gap configuration. At block 1212, the first RAN node transmits to the second RAN node a second message including a release indication indicating releasing the second gap configuration.

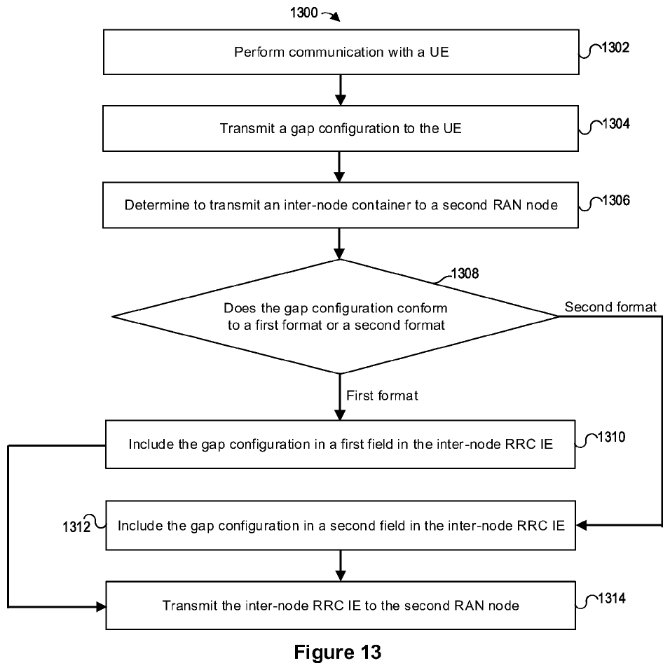

Referring next to FIG. 13, a method 1300 can be implemented in a first RAN node to transmit a gap configuration for a UE (e.g., the UE 102) to a second RAN node.

The method 1300 begins at block 1302, the first RAN node performs communication with the UE (e.g., events 302, 402. 502, 602, 702, 802). At block 1304, the first RAN node transmits a gap configuration to the UE. (e.g., events 304, 305, 303, 404, 405, 403, 504, 604, 704A, 705A, 704B, 705B, 704E, 705E, 804A, 805A, 804B, 805B, 804C, 805C). At block 1306, the first RAN node determines to transmit an inter-node message to the second RAN node. At block 1308, the first RAN node determines whether the gap configuration conforms to a first format or a second format. If the first RAN node determines that the gap configuration conforms to the first format, the flow proceeds to block 1310. At block 1310, the first RAN node includes the gap configuration in a first field in the inter-node message. If the first RAN node determines that the gap configuration conforms to the second format, the flow proceeds to block 1312. At block 1312, the first RAN node includes the gap configuration in a second field in the inter-node message. The flow proceeds to block 1314 from block 1310 as well as block 1312. At block 1314, the first RAN node transmits the inter-node message to the second RAN node.

In some implementations, the inter-node message can be an inter-node RRC IE. For example, the inter-node RRC IE is a CG-ConfigInfo IE.

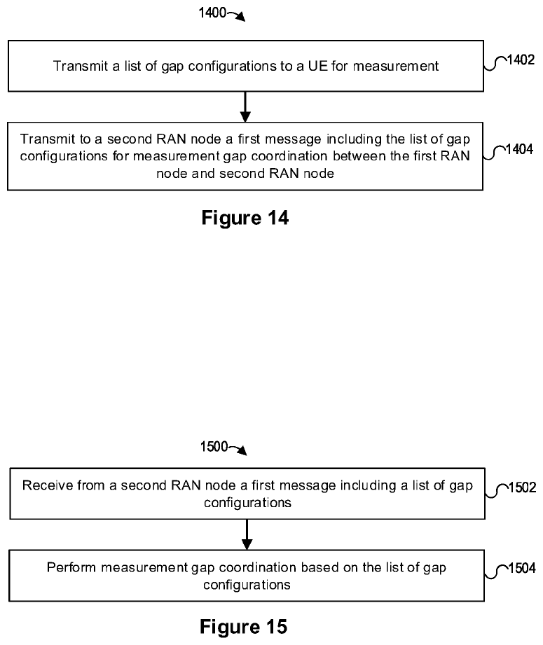

Referring next to FIG. 14, a method 1400 can be implemented in a first RAN node (e.g., the MN 104A or CU 172) to transmit a list of gap configurations for a UE (e.g., the UE 102) to a second RAN node (e.g., the SN 106A or S-DU 174B).

The method 1400 begins at block 1402, where the first RAN node transmits a list of gap configurations to a UE for measurement (e.g., events 304, 305, 303, 404, 405, 403, 504, 604, 704A, 705A, 704B, 705B, 704E, 705E, 804A, 805A, 804B, 805B, 804C, 805C). At block 1404, the first RAN node transmits to the second RAN node a first message including the list of gap configurations for measurement gap coordination between the first RAN node and second RAN node (e.g., events 308A, 308B, 308E, 326, 327, 390, 391, 408A, 408B, 408C, 490, 491, 508, 703A, 703B, 703C, 708A, 708B, 708E, 725A, 725B, 725C, 726, 790, 791, 808A, 808B, 808C, 890, and 891).

Referring next to FIG. 15, a method 1500 can be implemented in a first RAN node (e.g., SN 106A or S-DU 174B) to transmit a list of gap configurations for a UE (e.g., the UE 102) to a second RAN node (e.g., MN 104A or CU 172).

The method 1500 begins at block 1502, where the first RAN node receives from the second RAN node a first message including the list of gap configurations (e.g., events 308A, 308B, 308E, 326, 327, 390, 391, 408A, 408B, 408C, 490, 491, 508, 608, 703A, 703B, 703C, 708A, 708B, 708E, 725A, 725B, 725C, 726, 790, 791, 808A, 808B, 808C, 890, and 891). At block 1504, the first RAN node performs measurement gap coordination based on the list of gap configurations.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa.

A user device in which the methods described above can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the methods can be provided as part of the operating system, a library used by multiple applications, a particular software application, etc. The software can be executed by one or more general-purpose processors or one or more special-purpose processors.

1. A method in a second node of a radio access network (RAN) for managing communications with a UE configured to communicate in dual connectivity (DC) with a first node of the RAN and the second node, the method comprising:
receiving, from the first node, a message including (i) a configuration for a measurement gap which the UE uses for reference signal measurements and (ii) a status of the configuration; and
managing a scheduling of the communications between the UE and the second node in accordance with the status of the configuration.

2. The method of claim 1, wherein:
the first node operates as a master node (MN); and
the message includes a request to add the second node as a secondary node (SN).

3. The method of claim 1, wherein:
the first node operates as a master node (MN); and
the message includes a request to modify operation of the second node as a secondary node (SN).

4. The method of claim 1, wherein the status indicates activation of the configuration.

5. The method of claim 1, wherein the status indicates deactivation of the configuration.

6. The method of claim 5, wherein the managing of the scheduling includes:
refraining from scheduling at least one of (i) downlink transmissions to the UE or (ii) uplink transmission from the UE, in response to the status indicating the deactivation of the measurement.

7. The method of claim 1, wherein:
the first node is a first distributed unit (DU) of a distributed base station; and
the second node is a second DU of the distributed base station.

8. The method of claim 1,
wherein the configuration includes a gap identifier to identify a pre-configured configuration.

9. The method of claim 1, further comprising:
in response to a second message from the second node, release the configuration.

10. A method in a first node of a radio access network (RAN) for configuring reference signal measurements at a UE configured to communicate in dual connectivity (DC) with the first node and a second node of the RAN, the method comprising:
transmitting, to the second node, a message including (i) a configuration for a measurement gap and (ii) a status of the configuration; and
providing the configuration for the measurement gap to the UE for use with the reference signal measurements.

11. The method of claim 10, wherein the status indicates activation of the configuration.

12. The method of claim 10, wherein the status indicates deactivation of the configuration.

13. The method of claim 10, further comprising:
transmitting, to the second node, a second message including an indication to release the configuration.

14. The method of claim 10, wherein the configuration includes a gap identifier to identify a pre-configured configuration.

15. A first radio access network (RAN) node comprising:
a transceiver; and
processing hardware; the first RAN node adapted to configure reference signal measurements at a user equipment (UE) configured to communicate in dual connectivity (DC) with the first RAN node and a second RAN node, including:
transmit, to the second node, a message including (i) a configuration for a measurement gap and (ii) a status of the configuration, and
provide the configuration for the measurement gap to the UE for use with the reference signal measurements

16. The first RAN node of claim 15, wherein the status indicates activation of the configuration.

17. The first RAN node of claim 15, wherein the status indicates deactivation of the configuration.

18. The first RAN node of claim 15, further configured to:
transmit, to the second node, a second message including an indication to release the configuration.

19. The first RAN node of claim 15, wherein the configuration includes a gap identifier to identify a pre-configured configuration.

20. The first RAN node of claim 15, wherein:
the first RAN node is a first distributed unit (DU) of a distributed base station; and
the second RAN node is a second DU of the distributed base station.
